(19) United States
(12) Patent Application Publication
(10) Pub. No.: US 2026/0075594 A1
(43) Pub. Date: Mar. 12, 2026

(54) SPATIALLY-COUPLED MULTIPLE-INPUT MULTIPLE-OUTPUT TRANSMISSIONS WITH TAIL BITING

(71) Applicant: QUALCOMM Incorporated, San Diego, CA (US)

(72) Inventors: Wei YANG, San Diego, CA (US); Kirill IVANOV, La Jolla, CA (US); Thomas Joseph RICHARDSON, South Orange, NJ (US); Pinar SEN, San Diego, CA (US); Jing JIANG, San Diego, CA (US)

(21) Appl. No.: 18/883,505

(22) Filed: Sep. 12, 2024

(51) Int. Cl. H04W 72/0446; H04L 1/00; H04W 72/0453

(52) U.S. Cl. CPC H04W 72/0446; H04L 1/0003; H04W 72/0453

(57) ABSTRACT

Methods, systems, and devices for wireless communications are described. A user equipment (UE) may receive, via time-frequency resources using multiple spatial layers, a plurality of code block parts associated with a codeword, where code block parts corresponding to the same code blocks are each offset in different time-frequency resources, where one or more first code block parts are initializing code block parts associated with first decoding characteristics that are different than second decoding characteristics with which one or more second code block parts are associated. The UE may decode, based on the first decoding characteristics and the second decoding characteristics, the one or more first code block parts and the one or more second code block parts.

### FIELD OF TECHNOLOGY

The following relates to wireless communications, including spatially-coupled multiple-input multiple-output transmissions with tail biting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). In some examples, a wireless device may communicate using arrangements of codewords mapped to time-frequency resources. However, such approaches may be improved.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts and decoding, based on the first decoding characteristics and the second decoding characteristics, the one or more first code block parts and the one or more second code block parts.

A UE for wireless communications is described. The UE may include one or more memories storing processor executable code, and one or more processors coupled with the one or more memories. The one or more processors may individually or collectively be operable to execute the code to cause the UE to receive, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts and decode, based on the first decoding characteristics and the second decoding characteristics, the one or more first code block parts and the one or more second code block parts.

Another UE for wireless communications is described. The UE may include means for receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts and means for decoding, based on the first decoding characteristics and the second decoding characteristics, the one or more first code block parts and the one or more second code block parts.

A non-transitory computer-readable medium storing code for wireless communications is described. The code may include instructions executable by one or more processors to receive, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts and decode, based on the first decoding characteristics and the second decoding characteristics, the one or more first code block parts and the one or more second code block parts.

In some examples of the method, user equipment (UEs), and non-transitory computer-readable medium described herein, decoding the one or more first code block parts and the one or more second code block parts may include operations, features, means, or instructions for decoding, successively and based on the second decoding characteristics, the one or more second code block parts associated with corresponding second time-frequency resources of the set of multiple time-frequency resources based on cancellation of the decoded one or more first code block parts or decoded second code block parts from one or more respective signals associated with the one or more second code block parts and received during corresponding second time-frequency resources of the set of multiple time-frequency resources.

In some examples of the method, user equipment (UEs), and non-transitory computer-readable medium described herein, decoding, successively, the one or more second code block parts may include operations, features, means, or instructions for decoding respective first groups of second code block parts based on cancellation of respective second groups of second code block parts.

In some examples of the method, user equipment (UEs), and non-transitory computer-readable medium described herein, the first decoding characteristics include a first modulation and coding parameter that may be lower than a second modulation and coding parameter of the second decoding characteristics, and where the first modulation and coding parameter and the second modulation and coding parameter include respective modulation and coding scheme values, respective modulation orders, respective coding rates, or any combination thereof.

In some examples of the method, user equipment (UEs), and non-transitory computer-readable medium described herein, a value of the first modulation and coding parameter includes a fixed difference with respect to a value of the second modulation and coding parameter.

Some examples of the method, user equipment (UEs), and non-transitory computer-readable medium described herein may further include operations, features, means, or instructions for receiving control signaling including an indication of a value of the first modulation and coding parameter.

In some examples of the method, user equipment (UEs), and non-transitory computer-readable medium described herein, the first decoding characteristics include a first transmission power that may be higher than a second transmission power of the second decoding characteristics.

In some examples of the method, user equipment (UEs), and non-transitory computer-readable medium described herein, the first decoding characteristics include first channel conditions that may be different than second channel conditions of the second decoding characteristics.

Some examples of the method, user equipment (UEs), and non-transitory computer-readable medium described herein may further include operations, features, means, or instructions for receiving a message indicating a subset of the set of multiple time-frequency resources in which the one or more first code block parts may be located.

Some examples of the method, user equipment (UEs), and non-transitory computer-readable medium described herein may further include operations, features, means, or instructions for determining the first decoding characteristics and the second decoding characteristics based on measuring the first channel conditions, the second channel conditions, or both and determining the one or more first code block parts based on the determination of the first decoding characteristics and the second decoding characteristics.

In some examples of the method, user equipment (UEs), and non-transitory computer-readable medium described herein, the one or more first code block parts may be associated with a first channel estimation quality that may be greater than a second channel estimation quality with which the one or more second code block parts may be associated.

Some examples of the method, user equipment (UEs), and non-transitory computer-readable medium described herein may further include operations, features, means, or instructions for receiving the one or more first code block parts in a symbol of the set of multiple time-frequency resources that may be adjacent to a symbol in which a reference signal may be received.

Some examples of the method, user equipment (UEs), and non-transitory computer-readable medium described herein may further include operations, features, means, or instructions for receiving, in the first time-frequency resources and based on a frequency-based comb structure including one or more first resource elements and one or more second resource elements, at least a portion of the one or more first code block parts and a reference signal, where the reference signal occupies the one or more first resource elements of the frequency-based comb structure and the at least a portion of the one or more first code block parts occupies the one or more second resource elements of the frequency-based comb structure.

In some examples of the method, user equipment (UEs), and non-transitory computer-readable medium described herein, a first quantity of modulation symbols included in each of the one or more first code block parts may be a same quantity as a second quantity of modulation symbols included in each of the one or more second code block parts.

In some examples of the method, user equipment (UEs), and non-transitory computer-readable medium described herein, receiving the set of multiple code block parts may include operations, features, means, or instructions for receiving the set of multiple code block parts in a set of multiple symbols, where the one or more first code block parts may be received in a first-in-time symbol of the set of multiple symbols, no later than a reference symbol of the set of multiple symbols, no later than a first-in-time reference signal symbol of the set of multiple symbols, or no later than a last-in-time symbol of the set of multiple symbols.

In some examples of the method, user equipment (UEs), and non-transitory computer-readable medium described herein, the reference symbol may be an Nth-in-time symbol of the set of multiple symbols, and where N may be a fixed value, N may be based on a length of a transmission associated with the set of multiple code block parts, or N may be indicated via control signaling, or any combination thereof.

In some examples of the method, user equipment (UEs), and non-transitory computer-readable medium described herein, at least a portion of the one or more first code block parts may be associated with highest frequency resources of the set of multiple time-frequency resources, lowest frequency resources of the set of multiple time-frequency resources, or both.

In some examples of the method, user equipment (UEs), and non-transitory computer-readable medium described herein, respective portions of the set of multiple code block parts associated with respective spatial layers of the set of multiple spatial layers may be successively offset in the different time-frequency resources of the set of multiple time-frequency resources.

In some examples of the method, user equipment (UEs), and non-transitory computer-readable medium described herein, the set of multiple spatial layers includes a first group of spatial layers and a second group of spatial layers and one or more first portions of the set of multiple code block parts associated with the first group of spatial layers may be offset in the different time-frequency resources of the set of multiple time-frequency resources with respect to one or more second portions of the set of multiple code block parts associated with the second group of spatial layers.

A method for wireless communications by a network entity is described. The method may include encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts, transmitting, based on the first decoding characteristics, the one or more first code block parts during corresponding first time-frequency resources of the set of multiple time-frequency resources, and transmitting, based on the second decoding characteristics, the one or more second code block parts associated with corresponding second time-frequency resources of the set of multiple time-frequency resources.

A network entity for wireless communications is described. The network entity may include one or more memories storing processor executable code, and one or more processors coupled with the one or more memories. The one or more processors may individually or collectively be operable to execute the code to cause the network entity to encode, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts, transmit, based on the first decoding characteristics, the one or more first code block parts during corresponding first time-frequency resources of the set of multiple time-frequency resources, and transmit, based on the second decoding characteristics, the one or more second code block parts associated with corresponding second time-frequency resources of the set of multiple time-frequency resources.

Another network entity for wireless communications is described. The network entity may include means for encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts, means for transmitting, based on the first decoding characteristics, the one or more first code block parts during corresponding first time-frequency resources of the set of multiple time-frequency resources, and means for transmitting, based on the second decoding characteristics, the one or more second code block parts associated with corresponding second time-frequency resources of the set of multiple time-frequency resources.

A non-transitory computer-readable medium storing code for wireless communications is described. The code may include instructions executable by one or more processors to encode, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts, transmit, based on the first decoding characteristics, the one or more first code block parts during corresponding first time-frequency resources of the set of multiple time-frequency resources, and transmit, based on the second decoding characteristics, the one or more second code block parts associated with corresponding second time-frequency resources of the set of multiple time-frequency resources.

In some examples of the method, network entities, and non-transitory computer-readable medium described herein, the transmission of the one or more second code block parts may be based on a scheme for cancellation of the decoded one or more first code block parts or decoded second code block parts from one or more respective signals associated with the one or more second code block parts.

In some examples of the method, network entities, and non-transitory computer-readable medium described herein, the first decoding characteristics include a first modulation and coding parameter that may be lower than a second modulation and coding parameter of the second decoding characteristics, and where the first modulation and coding parameter and the second modulation and coding parameter include respective modulation and coding scheme values, respective modulation orders, respective coding rates, or any combination thereof.

In some examples of the method, network entities, and non-transitory computer-readable medium described herein, a value of the first modulation and coding parameter includes a fixed difference with respect to a value of the second and coding modulation parameter.

Some examples of the method, network entities, and non-transitory computer-readable medium described herein may further include operations, features, means, or instructions for transmitting control signaling including an indication of a value of the first modulation and coding parameter.

In some examples of the method, network entities, and non-transitory computer-readable medium described herein, the first decoding characteristics include a first transmission power that may be higher than a second transmission power of the second decoding characteristics.

In some examples of the method, network entities, and non-transitory computer-readable medium described herein, the first decoding characteristics include first channel conditions that may be different than second channel conditions of the second decoding characteristics.

Some examples of the method, network entities, and non-transitory computer-readable medium described herein may further include operations, features, means, or instructions for transmitting a message indicating a subset of the set of multiple time-frequency resources in which the one or more first code block parts may be located.

In some examples of the method, network entities, and non-transitory computer-readable medium described herein, the one or more first code block parts may be associated with a first channel estimation quality that may be greater than a second channel estimation quality with which the one or more second code block parts may be associated.

Some examples of the method, network entities, and non-transitory computer-readable medium described herein may further include operations, features, means, or instructions for transmitting the one or more first code block parts in a symbol of the set of multiple time-frequency resources that may be adjacent to a symbol in which a reference signal may be transmitted.

Some examples of the method, network entities, and non-transitory computer-readable medium described herein may further include operations, features, means, or instructions for transmitting, in the first time-frequency resources and based on a frequency-based comb structure including one or more first resource elements and one or more second resource elements, at least a portion of the one or more first code block parts and a reference signal, where the reference signal occupies the one or more first resource elements of the frequency-based comb structure and the at least a portion of the one or more first code block parts occupies the one or more second resource elements of the frequency-based comb structure.

In some examples of the method, network entities, and non-transitory computer-readable medium described herein, a first quantity of modulation symbols included in each of the one or more first code block parts may be a same quantity as a second quantity of modulation symbols included in each of the one or more second code block parts.

In some examples of the method, network entities, and non-transitory computer-readable medium described herein, transmitting the set of multiple code block parts may include operations, features, means, or instructions for transmitting the set of multiple code block parts in a set of multiple symbols, where the one or more first code block parts may be transmitted in a first-in-time symbol of the set of multiple symbols, no later than a reference symbol of the set of multiple symbols, no later than a first-in-time reference signal symbol of the set of multiple symbols, or no later than a last-in-time symbol of the set of multiple symbols.

In some examples of the method, network entities, and non-transitory computer-readable medium described herein, the reference symbol may be an Nth-in-time symbol of the set of multiple symbols, and where N may be a fixed value, N may be based on a length of a transmission associated with the set of multiple code block parts, N may be indicated via control signaling, or any combination thereof.

In some examples of the method, network entities, and non-transitory computer-readable medium described herein, at least a portion of the one or more first code block parts may be associated with highest frequency resources of the set of multiple time-frequency resources, lowest frequency resources of the set of multiple time-frequency resources, or both.

In some examples of the method, network entities, and non-transitory computer-readable medium described herein, respective portions of the set of multiple code block parts associated with respective spatial layers of the set of multiple spatial layers may be successively offset in the different time-frequency resources of the set of multiple time-frequency resources.

In some examples of the method, network entities, and non-transitory computer-readable medium described herein, the set of multiple spatial layers includes a first group of spatial layers and a second group of spatial layers and one or more first portions of the set of multiple code block parts associated with the first group of spatial layers may be offset in the different time-frequency resources of the set of multiple time-frequency resources with respect to one or more second portions of the set of multiple code block parts associated with the second group of spatial layers.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports spatially-coupled multiple-input multiple-output (SC-MIMO) transmissions with tail biting in accordance with one or more examples as disclosed herein.

FIG. 2 shows an example of a mapping scheme that supports SC-MIMO transmissions with tail biting in accordance with one or more examples as disclosed herein.

FIG. 3 shows an example of a wireless communications system that supports SC-MIMO transmissions with tail biting in accordance with one or more examples as disclosed herein.

FIG. 4 shows an example of a mapping scheme that supports SC-MIMO transmissions with tail biting in accordance with one or more examples as disclosed herein.

FIG. 5 shows an example of a mapping scheme that supports SC-MIMO transmissions with tail biting in accordance with one or more examples as disclosed herein.

FIG. 6 shows an example of a mapping scheme that supports SC-MIMO transmissions with tail biting in accordance with one or more examples as disclosed herein.

FIG. 7 shows an example of a mapping scheme that supports SC-MIMO transmissions with tail biting in accordance with one or more examples as disclosed herein.

FIG. 8 shows an example of a process flow that supports SC-MIMO transmissions with tail biting in accordance with one or more examples as disclosed herein.

FIGS. 9 and 10 show block diagrams of devices that support SC-MIMO transmissions with tail biting in accordance with one or more examples as disclosed herein.

FIG. 11 shows a block diagram of a communications manager that supports SC-MIMO transmissions with tail biting in accordance with one or more examples as disclosed herein.

FIG. 12 shows a diagram of a system including a device that supports SC-MIMO transmissions with tail biting in accordance with one or more examples as disclosed herein.

FIGS. 13 and 14 show block diagrams of devices that support SC-MIMO transmissions with tail biting in accordance with one or more examples as disclosed herein.

FIG. 15 shows a block diagram of a communications manager that supports SC-MIMO transmissions with tail biting in accordance with one or more examples as disclosed herein.

FIG. 16 shows a diagram of a system including a device that supports SC-MIMO transmissions with tail biting in accordance with one or more examples as disclosed herein.

FIGS. 17 and 18 show flowcharts illustrating methods that support SC-MIMO transmissions with tail biting in accordance with one or more examples as disclosed herein.

### DETAILED DESCRIPTION

In wireless communications, multiple spatial layers may be used to increase the capacity or other characteristics of wireless transmissions. Such transmissions may be transmitted using one or more codewords, which may be divided into code blocks (CBs) and CB parts. Such CBs may be transmitted to a receiving device across the multiple spatial layers. However, some approaches to transmitting such CBs may be improved, for example, to increase transmission rates and communication efficiency.

The techniques described herein involve the use of CB parts belonging to the same CB that may be offset between different spatial layers. For example, a first CB part may occupy a first time-frequency resource in a first spatial layer and a second CB part belonging to the same CB may occupy a second (e.g., a neighboring) time-frequency resource, such that pairs or other groups of CB parts of same CBs may occupy different time-frequency resources across the spatial layers. Such techniques also allow for sequential interference cancelation (SIC) techniques to be employed, for example, by canceling the effects of a first CB or CB part from a signal that also includes other CBs or CB parts. Further, due to the offset structure, “heads” and “tails” of a group of CBs may include resources in which a “special” or different CB or CB part may be transmitted. Such “special” or different CBs may be configured or designed to be relatively more easily decoded (e.g., due to one or more decoding characteristics) and may then be canceled from signals involving other CBs or CB parts, therefore facilitating SIC approaches while avoiding rate losses present by leaving such resources underutilized or unutilized. In some examples, such special or different CBs may be associated with decoding characteristics such as a relatively smaller modulation and coding parameter, a relatively higher transmit power, a relatively improved channel condition, or some proximity to a reference signal, among other examples. In at least these ways, communications quality, throughput, resource utilization, flexibility, and reliability may be increased while reducing overhead and latency.

Aspects of the disclosure are initially described in the context of wireless communications systems. Aspects of the disclosure are then described with reference to mapping schemes, a wireless communications system, and a process flow. Aspects of the disclosure are further illustrated by and described with reference to apparatus diagrams, system diagrams, and flowcharts that relate to spatially-coupled multiple-input multiple-output (SC-MIMO) transmissions with tail biting.

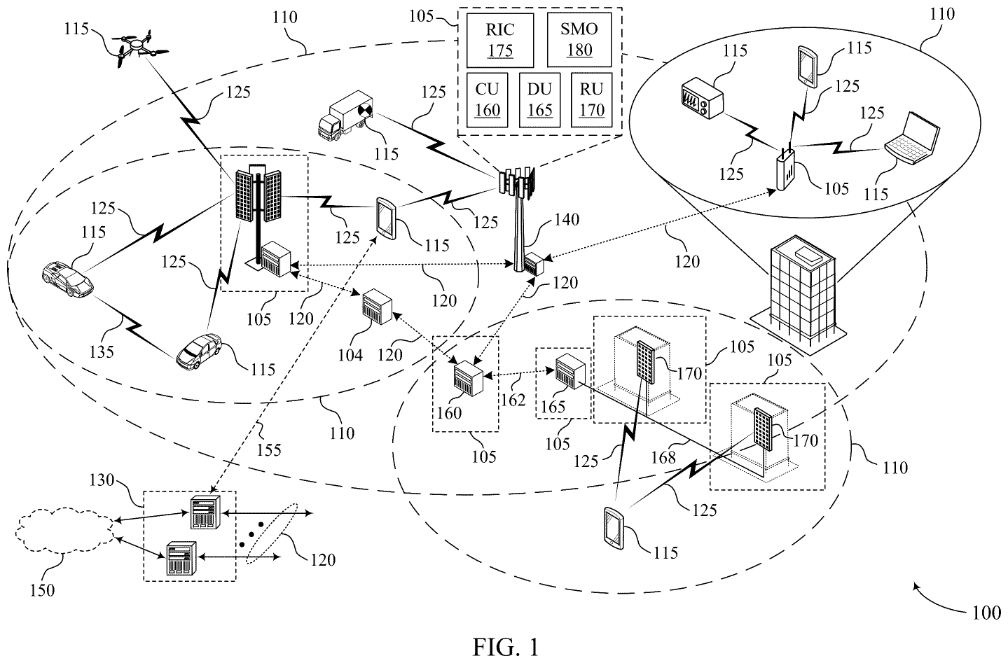

FIG. 1 shows an example of a wireless communications system 100 that supports SC-MIMO transmissions with tail biting in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δf ₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may receive communications from a network entity 105, which may be transmitted via multiple code words divided into CBs and CB parts over multiple layers. In some examples, CB parts corresponding to a same code word (or other groupings of CB parts) may be offset (e.g., in terms of the time-frequency resources) relative to one another across the multiple layers. For example, a first CB part may be associated with a first layer, a second CB part may be associated with a second layer, and the first CB part and the second CB part may occupy offset time-frequency resources (e.g., offset in time, in frequency, or both). Such an offset may be present for all CB parts for one or more symbols. Further, one or more CB parts of the CB parts may be special, initializing CB parts that may have characteristics that may permit them to be decoded more easily. These initializing CB parts allow for the UE to decode them more easily, which then may allow the other CB parts to be decoded via successive interference cancelation techniques, as CB parts in time-frequency resources of other layers (e.g., a layer that does not include the initializing CB at a corresponding time-frequency resource) that correspond to the initializing CBs may be decoded and successively canceled from signaling associated with other CB parts.

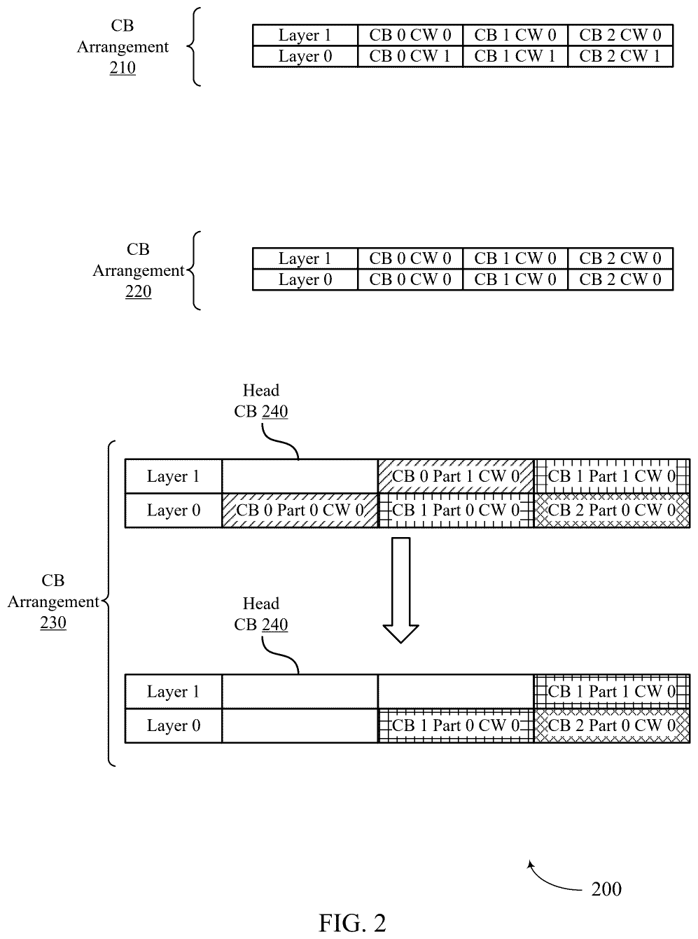

FIG. 2 shows an example of a mapping scheme 200 that supports SC-MIMO transmissions with tail biting in accordance with one or more examples as disclosed herein. The mapping scheme 200 may include multiple CB arrangements (e.g., CB arrangement 210, CB arrangement 220, CB arrangement 230) that may be used for transmission and reception (e.g., by a UE 115, by a network entity 105) of one or more codewords, where each codeword may include one or more CBs. In some examples, a codeword may be considered to be equivalent to a transport block in the context of the techniques described herein. Further, it should be understood that a CB may include multiple CB parts. As such, a codeword may include multiple CBs, and each CB may include multiple CB parts.

The CB arrangement 210 may depict a dual-codeword MIMO design structure, in which a first codeword (e.g., CW0) and a second codeword (e.g., CW1) may be assigned different rates. In some examples, a hard SIC technique may be applied in association with decoding the CBs. Such an arrangement may achieve a MIMO capacity (e.g., in association with a linear minimum mean squared error (LMMSE) and SIC receiver. However, in some examples, use of the CB arrangement 210 may involve additional considerations, such as the use of an accurate per-codeword channel quality indication (CQI) or separate outer-loops per codeword.

The CB arrangement 220 may depict a single-codeword design that may involve, for example, irregular low-density parity check (LDPC) codes. In some examples, use of the CB arrangement 220 may involve the use of a non-linear MIMO demodulation (e.g., per-stream recursive demapping (PSRD) or ePSRD) to obtain improved performance. Additionally, or alternatively, such techniques may involve the use of iterative demodulation or decoding across layers to achieve capacity. In some examples, the use of LDPCs (e.g., LDPCs based on the use of additive white Gaussian noise (AWGN)) may not be ideal for iterative demodulation or decoding. As such, in some examples, the use of the CB arrangement 220 may be less desirable (e.g., compared to the CB arrangement 210) in terms of performance.

The CB arrangement 230 may be a single codeword design that may include spatial coupling techniques (e.g., of a diagonal Bell Labs Layered Space-Time (D-BLAST) type or other spatial coupling techniques). In some examples involving the CB arrangement 230, a single codeword rate may be selected to match a collective channel quality across multiple layers. In some examples, a code structure similar to a D-BLAST structure may be employed (e.g., in which a single codeword captures relatively more channel realizations).

In some examples, demapping operations may involve successive interference cancellation. For example, CB0 may be demodulated and decoded first. If CB0 is successfully decoded, CB0 may be subtracted from the received signal, after which CB1 may be demodulated and decoded. If CB1 is successfully decoded, CB1 may be subtracted from the received signal. Such procedures may be repeated until all CBs are successfully decoded or CB decoding failure is declared. In some examples, the use of the CB arrangement 230 may be referred to as spatial coupling (SC) MIMO (SC-MIMO).

In some examples, however, the use of SC-MIMO may involve special or additional techniques for handling the head CB (and tail CB) of the SC chain (e.g., at the head CB 240), in order for the successive cancellation to start. For example, in some cases, the head CB 240 may be left empty, or known information may be included in the head CB 240, to enable the start of SC decoding. However, such approaches may result in a rate loss, which may not be negligible.

Thus, it may be desirable to employ designs that reduce the rate loss due to SC-MIMO on the one hand while promoting the performance gain of SC-MIMO and simplifying implementation at transmitting devices and receiving devices.

As described herein, a wireless communication device (e.g., a UE, a network entity) may receive, via time-frequency resources using multiple spatial layers, multiple CB parts associated with a codeword, where CB parts corresponding to the same CBs are each offset in different time-frequency resources. In some aspects, one or more first CB parts may be initializing CB parts associated with first decoding characteristics that are different than second decoding characteristics with which one or more second CB parts are associated. The wireless communication device may decode, based on the first decoding characteristics and the second decoding characteristics, the one or more first CB parts and the one or more second CB parts.

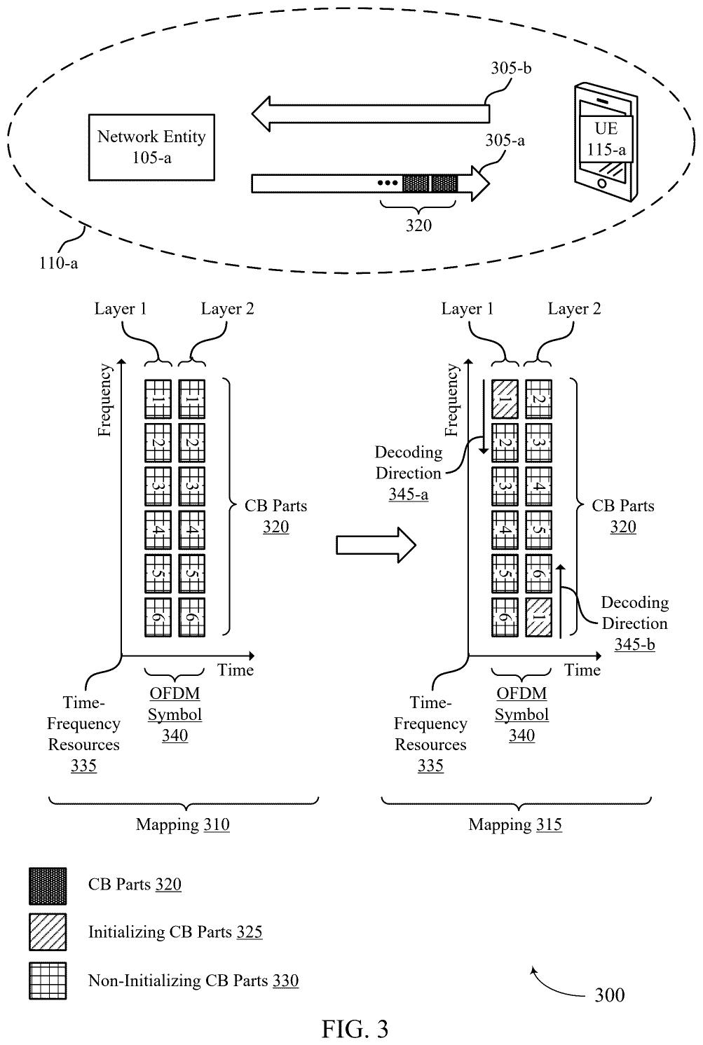

FIG. 3 shows an example of a wireless communications system 300 that supports SC-MIMO transmissions with tail biting in accordance with one or more examples as disclosed herein. The wireless communications system 300 may include the network entity 105-a, which may be an example of one or more network entities discussed in relation to other figures. The wireless communications system 300 may include the UE 115-a, which may be an example of UEs discussed in relation to other figures. In some examples, the UE 115-a may be located in a geographic coverage area 110-a that may be associated with the network entity 105-a. The network entity 105-a and UE 115-a may communicate via one or more downlink communication links 305-a and one or more uplink communication links 305-b.

The wireless communications system 300 may illustrate the use of “tail-biting” SC-MIMO for an example of a single OFDM symbol 340 for transmission.

Though a single OFDM symbol 340 is discussed, the techniques described herein are applicable to any quantity of symbols. Further, though an example of the network entity 105-a transmitting to the UE 115-a is described here, the techniques described herein may also be performed by any transmitting and receiving devices. Further, the techniques described herein may apply to any communications between any devices, including both uplink and downlink communications. For example, although examples described herein may use downlink communications (e.g., where a network entity transmits communications to a UE, and the UE receives such communications), it should be noted that any techniques described herein may apply to uplink communications (e.g., where a UE transmits communications to a network entity, and the network entity receives such communications). Further, the techniques described herein may apply to other types of communications (e.g., sidelink communications or other communications).

In some examples, the network entity 105-a may transmit the CB parts 320, which may belong to or be associated with multiple CBs and codewords. The CB parts 320 may be transmitted in a group or set of time-frequency resources 335. Further, the CB parts 320 may be transmitted such that CB parts associated with a second spatial layer, such as layer 2, may be offset relative to corresponding CB parts associated with a first spatial layer, such as layer 1. Mapping 310 shows the correspondence between the CB parts 320 of layer 1 and layer 2, and mapping 315 shows the offset arrangement of CB parts. CB parts 320 labeled with a same number may be CB parts 320 that correspond to one another (e.g., they are CB parts 320 of a same CB or other grouping of CB parts 320).

In some examples, the offset in the mapping 315 may be an offset of a length of one-half of a CB, which may result in the staggering pattern and coupling that may be used in SC-MIMO communications. In some examples, such an offset may contribute to the “head” and “tail” of the SC-MIMO chain being jointly decoded.

In some examples, one or more of the initializing CB parts 325 may be employed. Such initializing CB parts may be CB parts 320 that are less difficult or less complex for a receiving device (e.g., the UE 115-a) to decode, allowing a starting point for the SC-MIMO decoding procedure. Due to the offset nature of the CB parts 320, decoding of the CB parts may proceed in both “directions.” For example, decoding may be performed in the decoding direction 345-a or in the decoding direction 345-b. Either direction may be used, as the initializing CB parts 325 provide the “starting point” for the decoding process equally in either direction. For example, the UE 115-a may decode the CB part 320 labeled as 1, and continue to decode the CB parts 320 labeled as 2, then those labeled as 3, and so on in the decoding direction 345-a. Additionally, or alternatively, the UE 115-a may decode the CB part 320 labeled as 1 and continue to decode the CB parts 320 labeled as 6, then those labeled as 5, and so in in the decoding direction 345-b. Additionally, or alternatively, the UE may start decoding from one direction (e.g., the decoding direction 345-a), and if the decoding fails before the CB parts 320 are successfully decoded (e.g., decoding fails somewhere in the middle of the CB parts 320), the UE may decode in another direction (e.g., the decoding direction 345-b). This may increase the chance of successful decoding of the whole transport block (TB).

Various techniques may be employed to designate, produce, indicate, or determine the initializing CB parts 325. For example, the initializing CB parts 325 may be transmitted with a smaller MCS value, a lower modulation order, a lower coding rate, or any combination thereof (e.g., as compared to the non-initializing CB parts 330). In such cases, the index of the initializing CB parts 325 may be either predetermined (e.g., the first CB part 320, the CB part 320 in the middle, the last CB part 320, a CB part 320 of a predetermined index, or otherwise predetermined). Additionally, or alternatively, the index of the initializing CB parts 325 may be signaled from a transmitting device to a receiving device (e.g., signal by the network entity 105-a to the UE 115-a).

Additionally, or alternatively, the initializing CB parts 325 may be transmitted with a higher transmit power (e.g., as compared to the non-initializing CB parts 330). In such cases, the index of the initializing CB parts 325 may be either predetermined (e.g., the first CB part 320, the CB part 320 in the middle, the last CB part 320, a CB part 320 of a predetermined index, or otherwise predetermined). Additionally, or alternatively, the index of the initializing CB parts 325 may be signaled from a transmitting device to a receiving device (e.g., signal by the network entity 105-a to the UE 115-a).

Additionally, or alternatively, the initializing CB parts 325 may be transmitted with relatively improved or more favorable channel conditions. For example, the network entity 105-a may be aware of or possess some information about the channel or can (e.g., through various means) create a channel advantage for transmitting the initializing CB parts 325. For example, in some such cases involving a channel advantage to be used for the initializing CB parts 325, the network entity 105-a may transmit, to the UE 115-a, an indication of an index of one or more of the initializing CB parts 325, so that the UE 115-a is aware of which CB part 320 is the initializing CB parts 325 and is to be used to initiate the SC decoding process.

Additionally, or alternatively, to support the use of transmitting the initializing CB parts 325 with improved or more favorable channel conditions, the UE 115-a may determine which CB part 320 to decode first based on measurements of the channel conditions and may begin decoding from the CB part 320 with channel quality that is better than (e.g., based on one or more channel quality metrics) channel qualities of other CB parts 320. In other words, fading selectivity may be exploited to initialize SC-MIMO decoding.

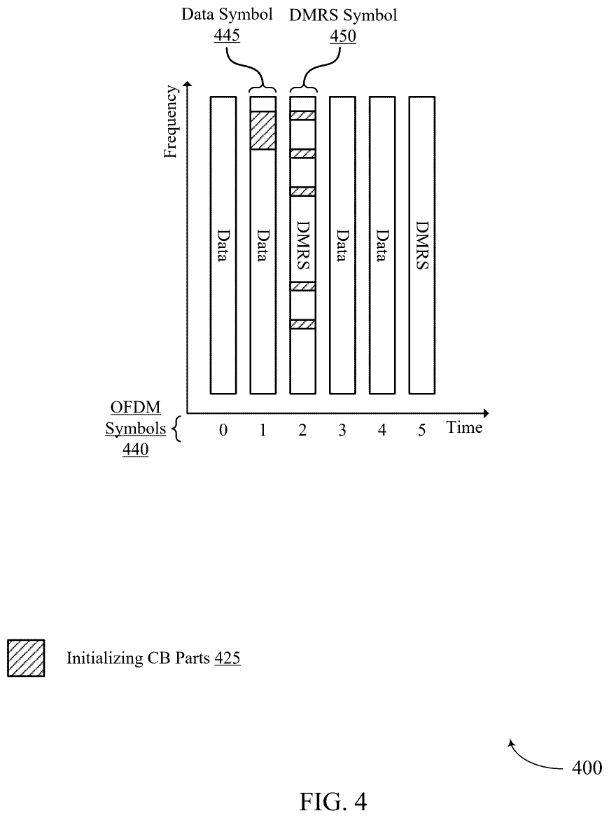

FIG. 4 shows an example of a mapping scheme 400 that supports SC-MIMO transmissions with tail biting in accordance with one or more examples as disclosed herein.

In some examples, the initializing CB parts 425 may be transmitted in or near a symbol (e.g., an OFDM symbol 440) or other position in time-frequency resources that may have increased channel estimation quality (e.g., as compared to other symbols or locations in time-frequency resources). For example, the initializing CB parts 425 may be located in a position that is close to (e.g., within a threshold distance of time, frequency, or both) to a reference signal symbol, such as a demodulation reference signal (DMRS) symbol, such as the DMRS symbol 450.

For example, in a first case, the initializing CB parts 425 may be located in a first OFDM symbol that is adjacent to the DMRS symbol 450, such as the data symbol 445 For example, if the DMRS located on symbol 2 (e.g., the DMRS symbol 450), then one or more of the initializing CB parts 425 may be located in symbol 1 (e.g., the data symbol 445). Additionally, or alternatively, in some examples, if the DMRS is “front-loaded” (e.g., a situation in which the DMRS is the first symbol of the transmission), then one or more initializing CB parts 425 may be placed in the immediately following OFDM symbol 440 after the DMRS symbol 450.

Additionally, or alternatively, in cases in which the DMRS may have a comb structure (e.g., DMRS is used or assigned to one or more other REs on the DMRS symbol 450) and data is mapped to the unused combs (e.g., unused REs on the DMRS symbol 450), then one or more of the initializing CB parts 425 may be mapped to such available REs on the DMRS symbol 450.

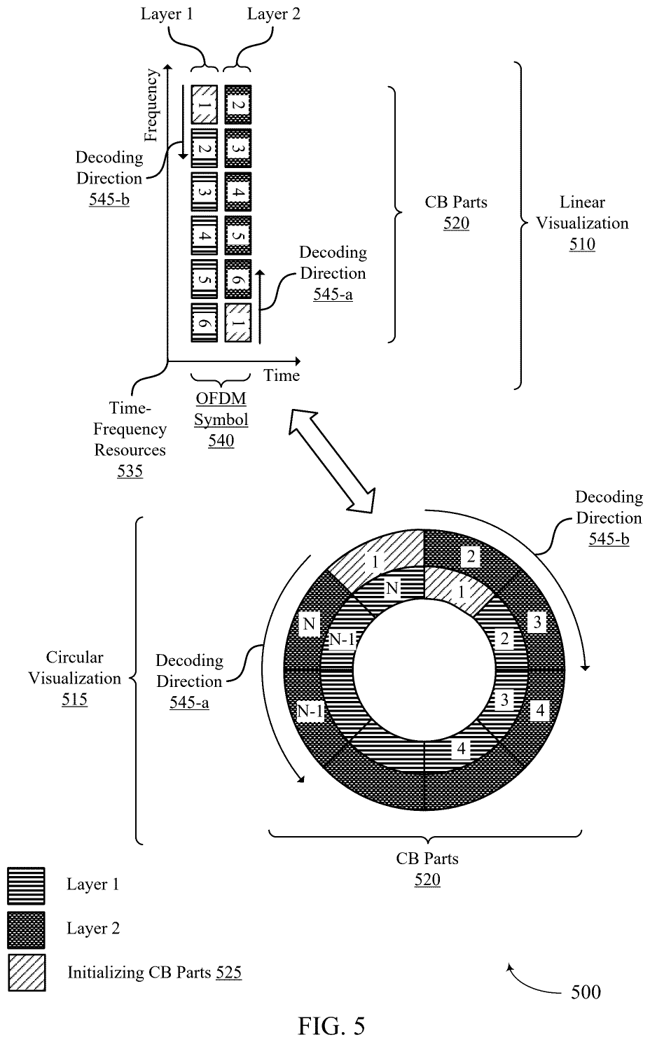

FIG. 5 shows an example of a mapping scheme 500 that supports SC-MIMO transmissions with tail biting in accordance with one or more examples as disclosed herein. The mapping scheme 500 may include or involve one or more of the linear visualization 510 and, the circular visualization 515, or both, which may involve the communications of the CB parts 520 in the time-frequency resources 535.

In some examples, the quantity of coded symbols in the initializing CB parts 525 may be a same quantity as a quantity of coded symbols in other CB parts (e.g., non-initializing CB parts). In cases in which the initializing CB parts 525 may be transmitted using a smaller MCS value, a lower modulation order, a lower coding rate, other modulation and coding parameter, or any combination thereof (e.g., as compared to the non-initializing CB parts), the initializing CB parts 525 may have or be associated with a relatively smaller information size (e.g., as compared to the non-initializing CB parts). Further, in such examples, one or more values of the MCS value, a relatively lower modulation order, a relatively lower coding rate, other modulation and coding parameter, or any combination thereof, may be of a fixed or known difference as compared to that of one or more non-initializing CB parts. For example, MC Sᵢₙᵢₜ=MC S_{regular}−x, where x may be 1, 2, 3 or another value, MC Sᵢₙᵢₜ is the value of the MCS for the initializing CB parts 525, and MC S_{regular} is the value of the MCS for the non-initializing CB parts. In some aspects, x may be a value communicated (e.g., signaled, indicated) between the transmitting device and the receiving device, which may be communicated via control signaling, such as downlink control information (DCI) signaling, radio resource control (RRC) signaling, medium access control-control element (MAC-CE) signaling, or other control signaling. Additionally, or alternatively, the MCS of the initializing CB parts 525 may be indicated by the network entity 105-a (or other transmitting device) to the UE 115-a (or other receiving device).

As depicted, the group of CB parts 520 to be transmitted may be visualized in a linear fashion, such as in the linear visualization 510, or in a circular fashion, such as in the circular visualization 515. In either depiction, the CB parts 520 of an OFDM symbol 540 may be visualized. In the linear visualization 510 and the circular visualization 515, either the decoding direction 545-b or the decoding direction 545-a may be employed. For instance, as shown in the circular visualization 515, either decoding direction 545 may be employed for decoding, as, regardless of the decoding direction 545 to be employed, the initializing CB parts 525 may provide a starting point for the SC decoding process to be performed.

For example, after the receiving device (e.g., a UE) decodes the initializing CB parts 525, the receiving device may continue decoding in either the decoding direction 545-b, the decoding direction 545-a, or a combination thereof. For example, the receiving device may decode using a first decoding direction (e.g., the decoding direction 545-a) until decoding fails and may subsequently switch to decoding in a second decoding direction (E.g., the decoding direction 545-b). Additionally, or alternatively, the receiving device may decode the CB parts 320 in both decoding directions 545 at the same time, until the two decoding threads meet each other.

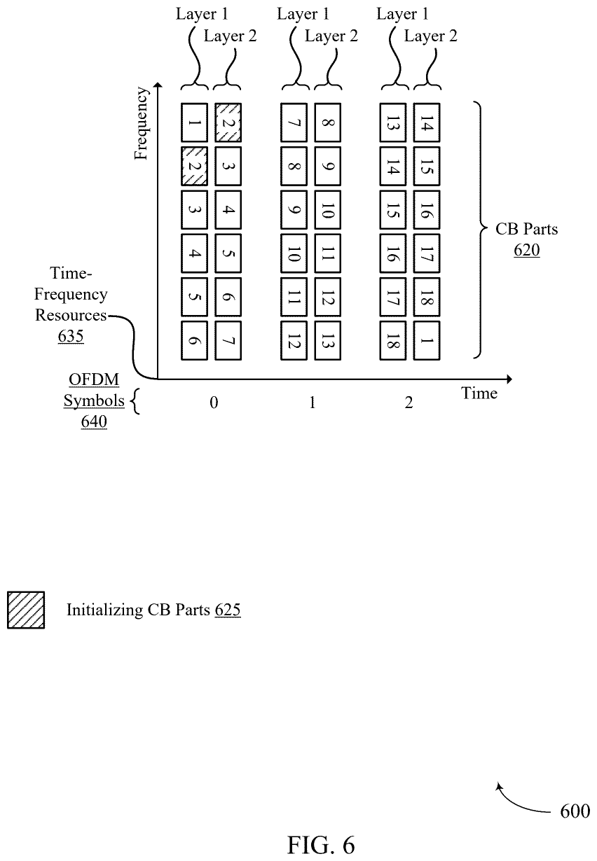

FIG. 6 shows an example of a mapping scheme 600 that supports SC-MIMO transmissions with tail biting in accordance with one or more examples as disclosed herein.

In some examples, the techniques described herein may be extended to multiple OFDM symbols 640 if the resources depicted elsewhere herein are considered to be time-frequency resources (e.g., by concatenating the multiple OFDM symbols).

However, in some cases, additional considerations or techniques for multiple OFDM symbols 640 may be desirable to further consider aspects of the time domain (e.g., latency).

In some examples, in the case of using multiple OFDM symbols 640 for transmission of the CB parts 620, one or more of the initializing CB parts 625 may be located at one or more locations in the time-frequency resources 635 and across multiple layers, such as layer 1 and layer 2. In some examples, the initializing CB parts 625 may be located on a first data symbol (e.g., symbol 0). Additionally, or alternatively, the initializing CB parts 625 may be located no later than the X-th symbol, where X may be either a fixed number or a non-fixed number (e.g., that may depend on or be based on the length of the transmission (e.g., based on the number of OFDM symbols of the transmission) or may be signaled from a transmitting device to a receiving device). Additionally, or alternatively, the initializing CB parts 625 may be located no later than a first DMRS symbol or a last DMRS symbol (e.g., which may be when the demodulation actually begins).

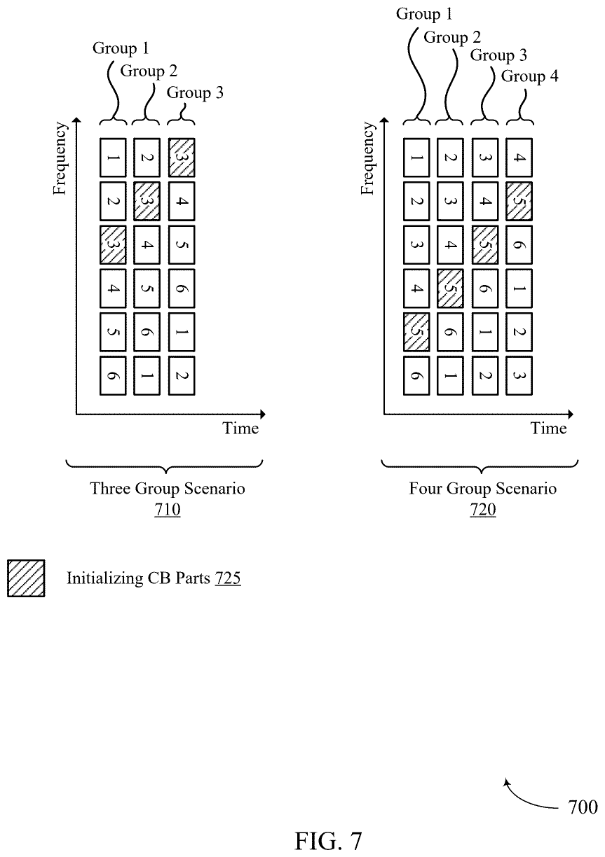

FIG. 7 shows an example of a mapping scheme 700 that supports SC-MIMO transmissions with tail biting in accordance with one or more examples as disclosed herein.

In some examples, the techniques described herein may be extended to different quantities of groups, such as in the three group scenario 710 or the four group scenario 720. The three group scenario 710 may involve spatial groups, such as group 1, group 2, and group 3. The four group scenario 720 may involve spatial groups, such as group 1, group 2, group 3, and group 4. Such groups may be referred to as spatial groups or layer groups interchangeably. A layer group may refer to one or more layers mapped to the same set of time-frequency resources (e.g., without an offset from each other) for a corresponding signal.

Elsewhere herein, the examples describe the use of two spatial groups or layer groups. For example, the discussion herein made with reference to at least FIGS. 3 through 6 involving two layer groups may be termed to be a “1+1” case, in which there are two layer groups, with each layer group being made of a single layer. However, it is to be understood that any and all examples described herein as involving layers may also be applied to spatial groups, each of which may include one or more layers. Such techniques may also apply to the three group scenario 710 and the four group scenario 720, in which multiple layers or groups of layers may be considered.

For example, in the case of four layers, different grouping of layers across the layer groups is possible. For example, a first layer group may include two layers and a second layer group may include two layers, resulting in a “2+2” scenario. In such a case (or indeed, any case involving layer groups that have two layers), the techniques described herein with reference to at least FIGS. 2-6 may be applied to the two layer groups. For example, each CB will map to both of the two layer layers, with a half-CB offset among the two layer groups. In some cases, in the case of four groups or layers (or indeed any case of an even quantity of groups or layers), techniques described herein in relation to two groups or layers may be applied to the four groups or layers in a 2+2 fashion (or a 2+2+2 fashion, a 2+2+2+2 fashion, and so on, for different quantities of groups or layers), in which such techniques are applied multiple times to pairings of groups or layers.

Additionally, or alternatively, other layer group combinations may be employed. For example, a “1+1+2” scenario may be considered, in which a first layer group has a single layer, a second layer group has a single layer, and a third layer group has two layers. Such an arrangement could be applied to the three group scenario 710, for example.

Additionally, or alternatively, four layers may form four layer groups, where each layer group includes a single layer, resulting in a “1+1+1+1” scenario. The four group scenario 720 is one example of such a scenario.

The “tail-biting” structure, however, may be applied to any quantity of groups or layers, such as described and depicted with reference to the three group scenario 710 and the four group scenario 720. In such examples, each group or layer may be offset or cyclically-shifted by multiples of ⅓ or ¼ of the CB length (e.g., the quantity of coded symbols). For example, given a quantity x of groups or layers, the offset or shift may be made at multiples of 1/x for each group or layer. Further, given a different quantity of groups or layers, different quantities of initializing CB parts 725 may be employed. For example, in the three layer group scenario 710, three initializing CB parts 725 may be employed and, similarly, in the four group scenario 720, four initializing CB parts 725 may be employed.

Further, as described herein, a single CB part may be used as the initializing CB part 725 for a layer group. For example, FIG. 7 depicts that CB 3 is the initializing CB part 725 for the three group scenario 710, and CB 5 is the initializing CB part 725 for the four group scenario 720. However, in some scenarios involving, for example, more than 2 layer groups, more than one initializing CB part 725 may be employed. For instance, multiple (e.g., two) initializing CB parts 725 may be employed for the three group scenario 710 (e.g., for each layer group). In another example, the four group scenario 720 may utilize multiple (e.g., three) initializing CB parts 725 (e.g., for each layer group). In such cases of multiple initializing CB parts 725, some or all of the initializing CB parts may have some parameters that may contribute to improved decoding, such as a relatively smaller MCS or other decoding advantages compared to the other CBs (e.g., some or all of the decoding advantages or characteristics of initializing CB parts, as described herein). It should be noted that the multi-layer aspect as described herein is different from spatial-coupled LDPC codes and tail-biting convolutional codes.

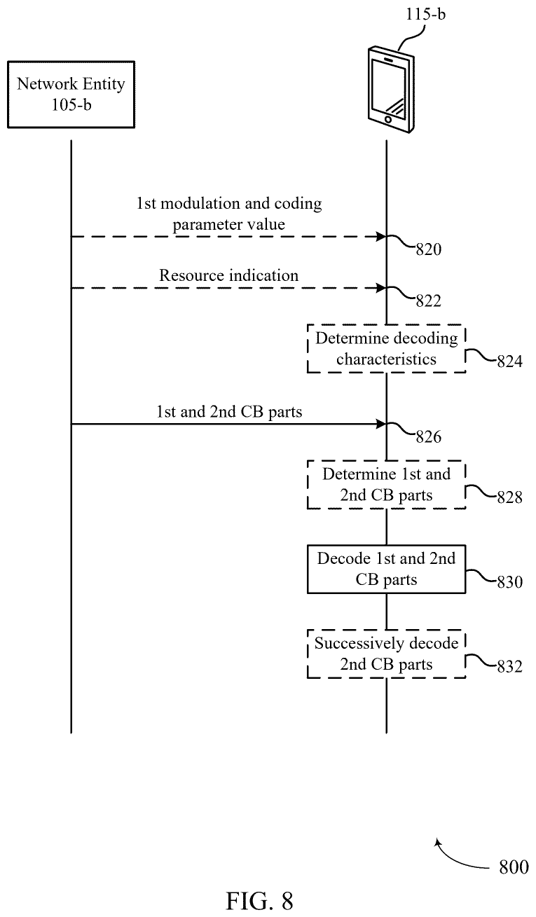

FIG. 8 shows an example of a process flow 800 that supports SC-MIMO transmissions with tail biting in accordance with one or more examples as disclosed herein.

The process flow 800 may implement various aspects of the present disclosure described herein. The elements described in the process flow 800 (e.g., UE 115-b and network entity 105-b) may be examples of similarly named elements described herein.

In the following description of the process flow 800, the operations between the various entities or elements may be performed in different orders or at different times. Some operations may also be left out of the process flow 800, or other operations may be added. Although the various entities or elements are shown performing the operations of the process flow 800, some aspects of some operations may also be performed by other entities or elements of the process flow 800 or by entities or elements that are not depicted in the process flow, or any combination thereof.

At 820, the UE 115-b may receive control signaling that may include an indication of a value of the first modulation and coding parameter.

At 822, the UE 115-b may receive a message indicating a subset of the plurality of time-frequency resources in which the one or more first code block parts are located.

At 824, the UE 115-b may determine the first decoding characteristics and the second decoding characteristics based on measuring the first channel conditions, the second channel conditions, or both.

At 826, the UE 115-b may receive, via a plurality of time-frequency resources using a plurality of spatial layers, a plurality of code block parts associated with a codeword and respective code block parts of the plurality of code block parts corresponding to the same code blocks are each offset in different time-frequency resources of the plurality of time-frequency resources and one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts. In some examples, the first decoding characteristics comprise a first modulation and coding parameter that is lower than a second modulation and coding parameter of the second decoding characteristics, and wherein the first modulation and coding parameter and the second modulation and coding parameter comprise respective modulation and coding scheme values, respective modulation orders, respective coding rates, or any combination thereof. In some examples, a value of the first modulation and coding parameter may include a fixed difference with respect to a value of the second modulation and coding parameter. In some examples, the first decoding characteristics comprise a first transmission power that is higher than a second transmission power of the second decoding characteristics. In some examples, the first decoding characteristics comprise first channel conditions that are different than second channel conditions of the second decoding characteristics. In some examples, the one or more first code block parts are associated with a first channel estimation quality that is greater than a second channel estimation quality with which the one or more second code block parts are associated.

In some examples, the UE 115-b may receive the one or more first code block parts in a symbol of the plurality of time-frequency resources that is adjacent to a symbol in which a reference signal is received. Additionally, or alternatively, the UE 115-b may receive, in first time-frequency resources of the plurality of time-frequency resources and based on a frequency-based comb structure that may include one or more first resource elements and one or more second resource elements, at least a portion of the one or more first code block parts and a reference signal and the reference signal occupies the one or more first resource elements of the frequency-based comb structure and the at least a portion of the one or more first code block parts occupies the one or more second resource elements of the frequency-based comb structure.

In some examples, a first quantity of modulation symbols included in each of the one or more first code block parts is a same quantity as a second quantity of modulation symbols included in each of the one or more second code block parts.

In some examples, the UE 115-b may receive the plurality of code block parts in a plurality of symbols and the one or more first code block parts are received in a first-in-time symbol of the plurality of symbols, no later than a reference symbol of the plurality of symbols, no later than a first-in-time reference signal symbol of the plurality of symbols, or no later than a last-in-time symbol of the plurality of symbols. In some examples, the reference symbol is an Nth-in-time symbol of the plurality of symbols, and wherein N is a fixed value, N is based on a length of a transmission associated with the plurality of code block parts, or N is indicated via control signaling, or any combination thereof.

In some examples, at least a portion of the one or more first code block parts are associated with highest frequency resources of the plurality of time-frequency resources, lowest frequency resources of the plurality of time-frequency resources, or both.

In some examples, respective portions of the plurality of code block parts associated with respective spatial layers of the plurality of spatial layers are successively offset in the different time-frequency resources of the plurality of time-frequency resources.

In some examples, the plurality of spatial layers may include a first group of spatial layers and a second group of spatial layers. In some examples, one or more first portions of the plurality of code block parts associated with the first group of spatial layers are offset in the different time-frequency resources of the plurality of time-frequency resources with respect to one or more second portions of the plurality of code block parts associated with the second group of spatial layers.

At 828, the UE 115-b may determine the one or more first code block parts based on the determination of the first decoding characteristics and the second decoding characteristics.

At 830, the UE 115-b may decode, based on the first decoding characteristics and the second decoding characteristics, the one or more first code block parts and the one or more second code block parts.

At 832, the UE 115-b may decode, successively and based on the second decoding characteristics, the one or more second code block parts associated with corresponding second time-frequency resources of the plurality of time-frequency resources based on cancellation of the decoded one or more first code block parts or decoded second code block parts from one or more respective signals associated with the one or more second code block parts and received during corresponding second time-frequency resources of the plurality of time-frequency resources. In some examples, to decode the one or more second code block parts, the UE 115-b may decode respective first groups of second code block parts based on cancellation of respective second groups of second code block parts.

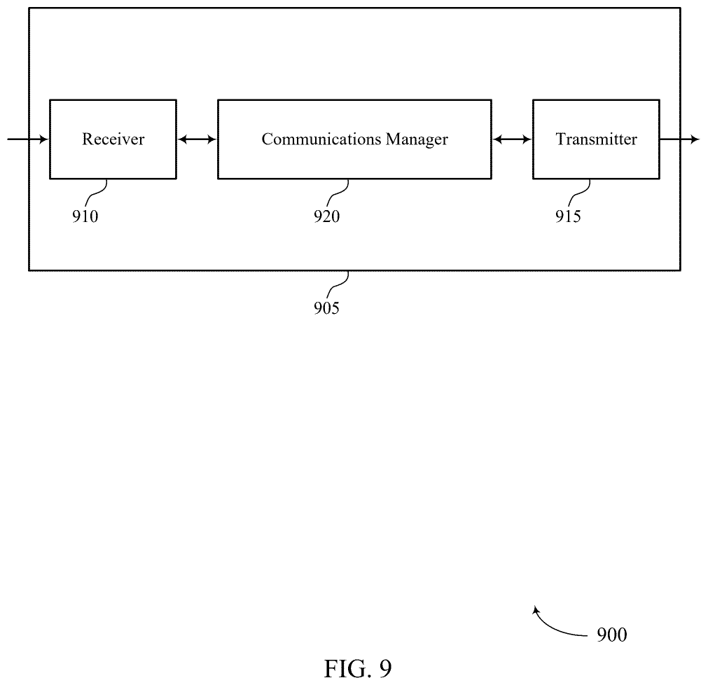

FIG. 9 shows a block diagram 900 of a device 905 that supports SC-MIMO transmissions with tail biting in accordance with one or more examples as disclosed herein. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to SC-MIMO transmissions with tail biting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SC-MIMO transmissions with tail biting). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of SC-MIMO transmissions with tail biting as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

Additionally, or alternatively, the communications manager 920 may support wireless communications in accordance with examples as disclosed herein. For example, the communications manager 920 is capable of, configured to, or operable to support a means for receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The communications manager 920 is capable of, configured to, or operable to support a means for decoding, based on the first decoding characteristics and the second decoding characteristics, the one or more first code block parts and the one or more second code block parts.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, or any combination thereof.

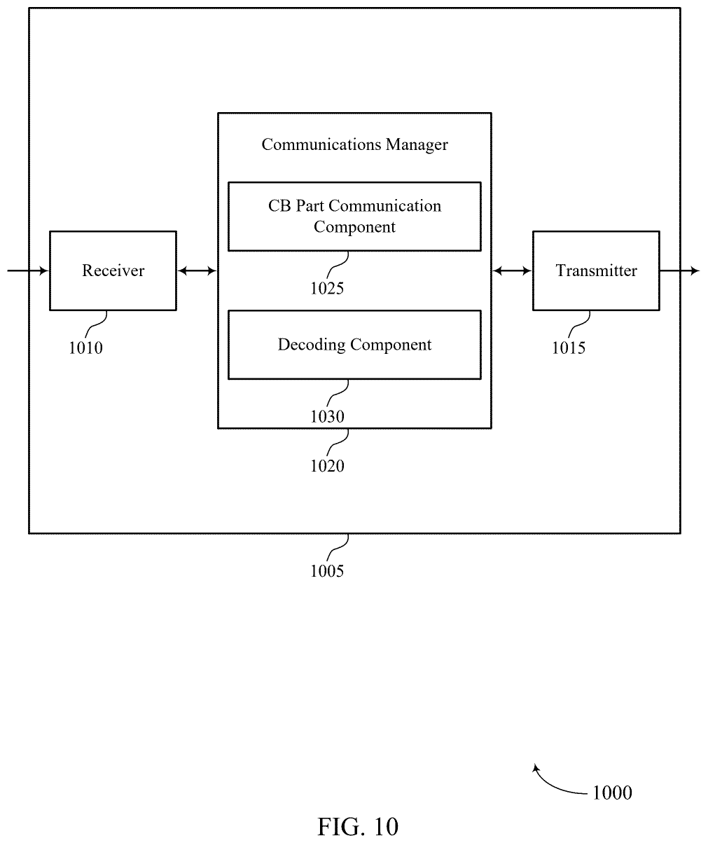

FIG. 10 shows a block diagram 1000 of a device 1005 that supports SC-MIMO transmissions with tail biting in accordance with one or more examples as disclosed herein. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to SC-MIMO transmissions with tail biting). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to SC-MIMO transmissions with tail biting). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of SC-MIMO transmissions with tail biting as described herein. For example, the communications manager 1020 may include a CB part communication component 1025 a decoding component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The CB part communication component 1025 is capable of, configured to, or operable to support a means for receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The decoding component 1030 is capable of, configured to, or operable to support a means for decoding, based on the first decoding characteristics and the second decoding characteristics, the one or more first code block parts and the one or more second code block parts.

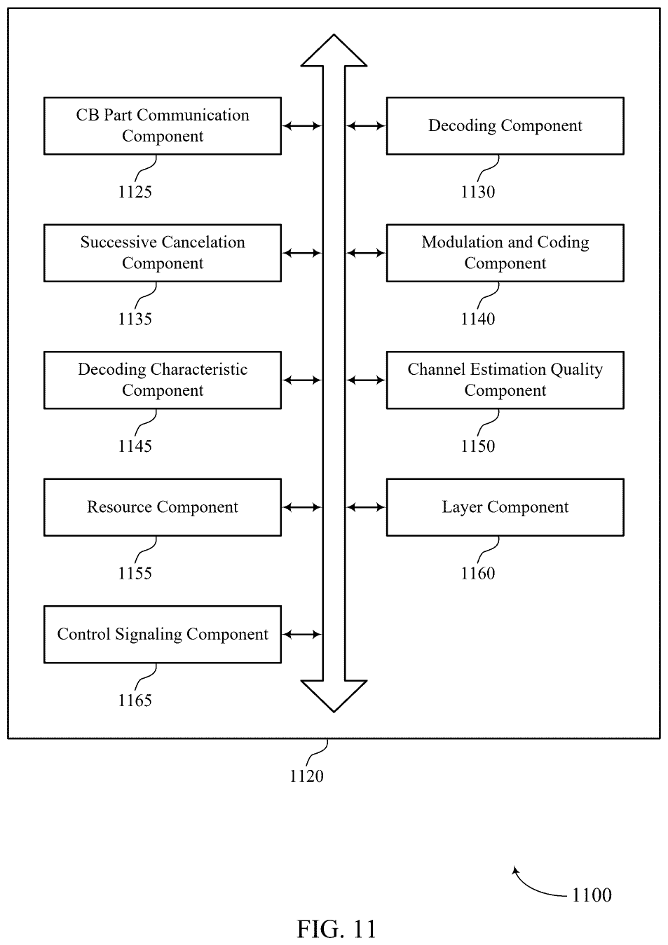

FIG. 11 shows a block diagram 1100 of a communications manager 1120 that supports SC-MIMO transmissions with tail biting in accordance with one or more examples as disclosed herein. The communications manager 1120 may be an example of aspects of a communications manager 920, a communications manager 1020, or both, as described herein. The communications manager 1120, or various components thereof, may be an example of means for performing various aspects of SC-MIMO transmissions with tail biting as described herein. For example, the communications manager 1120 may include a CB part communication component 1125, a decoding component 1130, a successive cancelation component 1135, a modulation and coding component 1140, a decoding characteristic component 1145, a channel estimation quality component 1150, a resource component 1155, a layer component 1160, a control signaling component 1165, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1120 may support wireless communications in accordance with examples as disclosed herein. The CB part communication component 1125 is capable of, configured to, or operable to support a means for receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The decoding component 1130 is capable of, configured to, or operable to support a means for decoding, based on the first decoding characteristics and the second decoding characteristics, the one or more first code block parts and the one or more second code block parts.

In some examples, to support decoding the one or more first code block parts and the one or more second code block parts, the successive cancelation component 1135 is capable of, configured to, or operable to support a means for decoding, successively and based on the second decoding characteristics, the one or more second code block parts associated with corresponding second time-frequency resources of the set of multiple time-frequency resources based on cancellation of the decoded one or more first code block parts or decoded second code block parts from one or more respective signals associated with the one or more second code block parts and received during corresponding second time-frequency resources of the set of multiple time-frequency resources.

In some examples, to support decoding, successively, the one or more second code block parts, the decoding component 1130 is capable of, configured to, or operable to support a means for decoding respective first groups of second code block parts based on cancellation of respective second groups of second code block parts.

In some examples, the first decoding characteristics include a first modulation and coding parameter that is lower than a second modulation and coding parameter of the second decoding characteristics, and where the first modulation and coding parameter and the second modulation and coding parameter include respective modulation and coding scheme values, respective modulation orders, respective coding rates, or any combination thereof.

In some examples, a value of the first modulation and coding parameter includes a fixed difference with respect to a value of the second modulation and coding parameter.

In some examples, the control signaling component 1165 is capable of, configured to, or operable to support a means for receiving control signaling including an indication of a value of the first modulation and coding parameter.

In some examples, the first decoding characteristics include a first transmission power that is higher than a second transmission power of the second decoding characteristics.

In some examples, the first decoding characteristics include first channel conditions that are different than second channel conditions of the second decoding characteristics.

In some examples, the resource component 1155 is capable of, configured to, or operable to support a means for receiving a message indicating a subset of the set of multiple time-frequency resources in which the one or more first code block parts are located.

In some examples, the decoding characteristic component 1145 is capable of, configured to, or operable to support a means for determining the first decoding characteristics and the second decoding characteristics based on measuring the first channel conditions, the second channel conditions, or both. In some examples, the decoding characteristic component 1145 is capable of, configured to, or operable to support a means for determining the one or more first code block parts based on the determination of the first decoding characteristics and the second decoding characteristics.

In some examples, the one or more first code block parts are associated with a first channel estimation quality that is greater than a second channel estimation quality with which the one or more second code block parts are associated.

In some examples, the CB part communication component 1125 is capable of, configured to, or operable to support a means for receiving the one or more first code block parts in a symbol of the set of multiple time-frequency resources that is adjacent to a symbol in which a reference signal is received.

In some examples, the CB part communication component 1125 is capable of, configured to, or operable to support a means for receiving, in first time-frequency resources of the plurality of time-frequency resources and based on a frequency-based comb structure including one or more first resource elements and one or more second resource elements, at least a portion of the one or more first code block parts and a reference signal, where the reference signal occupies the one or more first resource elements of the frequency-based comb structure and the at least a portion of the one or more first code block parts occupies the one or more second resource elements of the frequency-based comb structure.

In some examples, a first quantity of modulation symbols included in each of the one or more first code block parts is a same quantity as a second quantity of modulation symbols included in each of the one or more second code block parts.

In some examples, to support receiving the set of multiple code block parts, the CB part communication component 1125 is capable of, configured to, or operable to support a means for receiving the set of multiple code block parts in a set of multiple symbols, where the one or more first code block parts are received in a first-in-time symbol of the set of multiple symbols, no later than a reference symbol of the set of multiple symbols, no later than a first-in-time reference signal symbol of the set of multiple symbols, or no later than a last-in-time symbol of the set of multiple symbols.

In some examples, the reference symbol is an Nth-in-time symbol of the set of multiple symbols, and where N is a fixed value, N is based on a length of a transmission associated with the set of multiple code block parts, or N is indicated via control signaling, or any combination thereof.

In some examples, at least a portion of the one or more first code block parts are associated with highest frequency resources of the set of multiple time-frequency resources, lowest frequency resources of the set of multiple time-frequency resources, or both.

In some examples, respective portions of the set of multiple code block parts associated with respective spatial layers of the set of multiple spatial layers are successively offset in the different time-frequency resources of the set of multiple time-frequency resources.

In some examples, the set of multiple spatial layers includes a first group of spatial layers and a second group of spatial layers. In some examples, one or more first portions of the set of multiple code block parts associated with the first group of spatial layers are offset in the different time-frequency resources of the set of multiple time-frequency resources with respect to one or more second portions of the set of multiple code block parts associated with the second group of spatial layers.

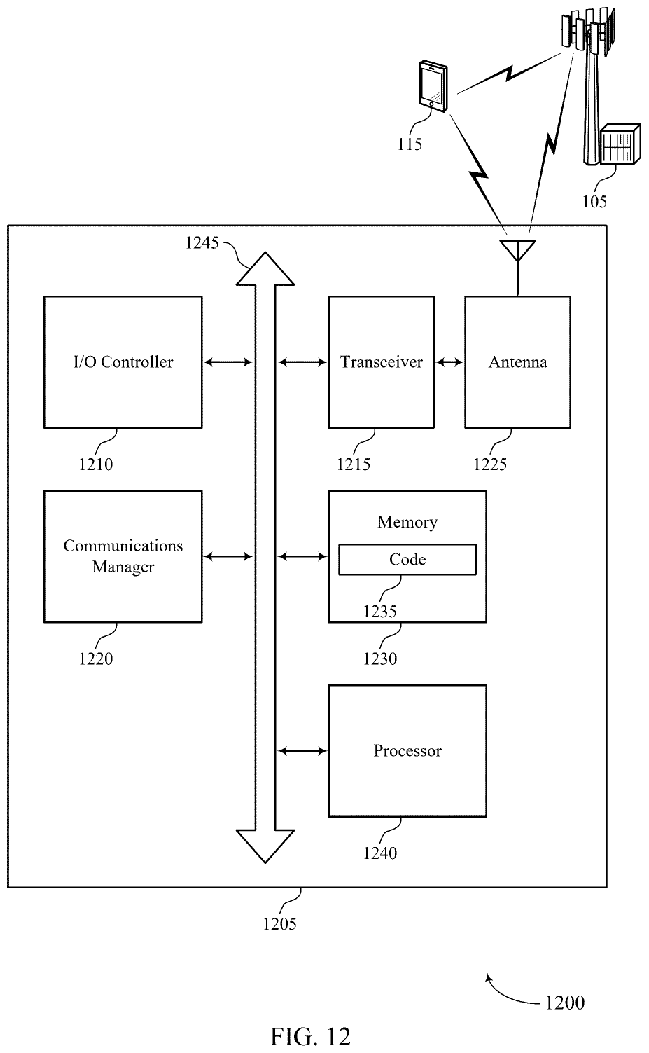

FIG. 12 shows a diagram of a system 1200 including a device 1205 that supports SC-MIMO transmissions with tail biting in accordance with one or more examples as disclosed herein. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®,UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting SC-MIMO transmissions with tail biting). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

Additionally, or alternatively, the communications manager 1220 may support wireless communications in accordance with examples as disclosed herein. For example, the communications manager 1220 is capable of, configured to, or operable to support a means for receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The communications manager 1220 is capable of, configured to, or operable to support a means for decoding, based on the first decoding characteristics and the second decoding characteristics, the one or more first code block parts and the one or more second code block parts.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of SC-MIMO transmissions with tail biting as described herein, or the at least one processor 1240 and the at least one memory 1230 may be otherwise configured to, individually or collectively, perform or support such operations.

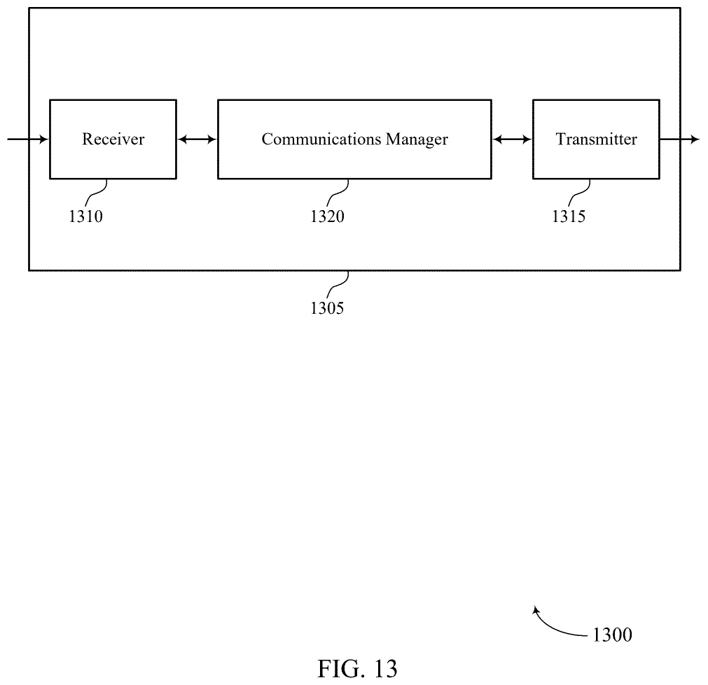

FIG. 13 shows a block diagram 1300 of a device 1305 that supports SC-MIMO transmissions with tail biting in accordance with one or more examples as disclosed herein. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas.

Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of SC-MIMO transmissions with tail biting as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

Additionally, or alternatively, the communications manager 1320 may support wireless communications in accordance with examples as disclosed herein. For example, the communications manager 1320 is capable of, configured to, or operable to support a means for encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The communications manager 1320 is capable of, configured to, or operable to support a means for transmitting, based on the first decoding characteristics, the one or more first code block parts during corresponding first time-frequency resources of the set of multiple time-frequency resources. The communications manager 1320 is capable of, configured to, or operable to support a means for transmitting, based on the second decoding characteristics, the one or more second code block parts associated with corresponding second time-frequency resources of the set of multiple time-frequency resources.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced processing, reduced power consumption, more efficient utilization of communication resources, or any combination thereof.

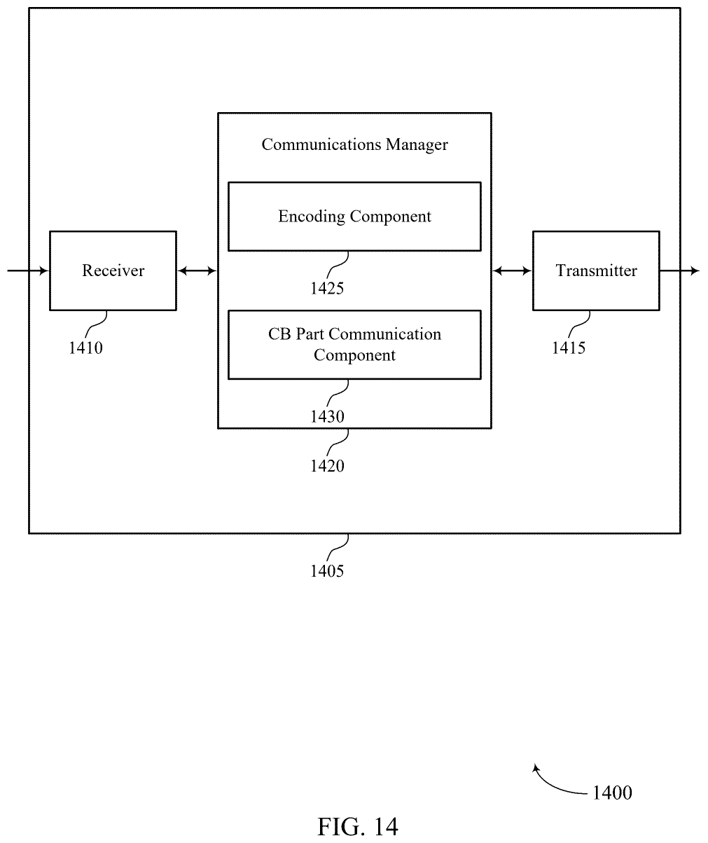

FIG. 14 shows a block diagram 1400 of a device 1405 that supports SC-MIMO transmissions with tail biting in accordance with one or more examples as disclosed herein. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of SC-MIMO transmissions with tail biting as described herein. For example, the communications manager 1420 may include an encoding component 1425 a CB part communication component 1430, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The encoding component 1425 is capable of, configured to, or operable to support a means for encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The CB part communication component 1430 is capable of, configured to, or operable to support a means for transmitting, based on the first decoding characteristics, the one or more first code block parts during corresponding first time-frequency resources of the set of multiple time-frequency resources. The CB part communication component 1430 is capable of, configured to, or operable to support a means for transmitting, based on the second decoding characteristics, the one or more second code block parts associated with corresponding second time-frequency resources of the set of multiple time-frequency resources.

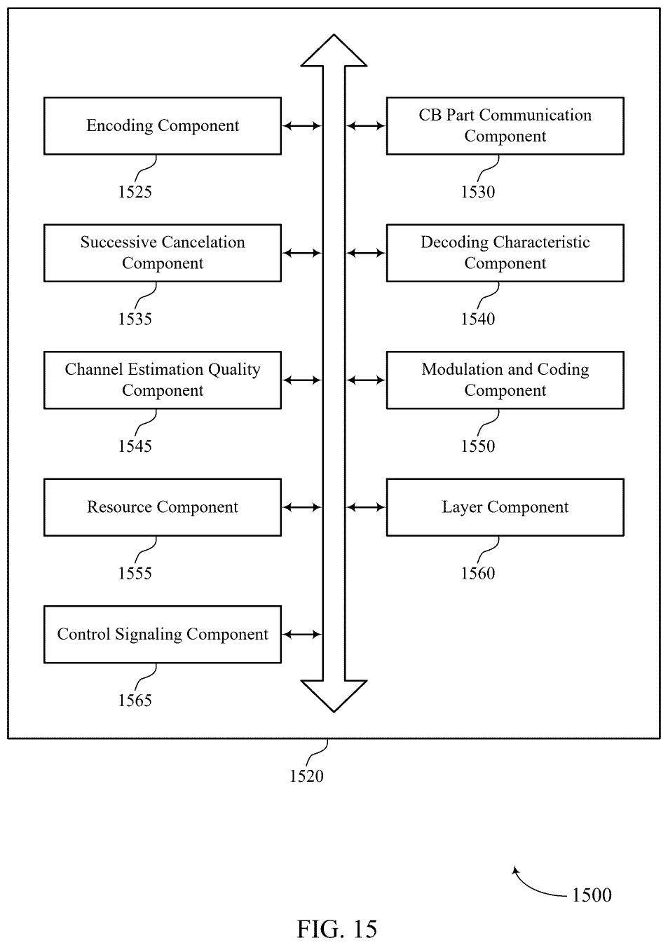

FIG. 15 shows a block diagram 1500 of a communications manager 1520 that supports SC-MIMO transmissions with tail biting in accordance with one or more examples as disclosed herein. The communications manager 1520 may be an example of aspects of a communications manager 1320, a communications manager 1420, or both, as described herein. The communications manager 1520, or various components thereof, may be an example of means for performing various aspects of SC-MIMO transmissions with tail biting as described herein. For example, the communications manager 1520 may include an encoding component 1525, a CB part communication component 1530, a successive cancelation component 1535, a decoding characteristic component 1540, a channel estimation quality component 1545, a modulation and coding component 1550, a resource component 1555, a layer component 1560, a control signaling component 1565, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1520 may support wireless communications in accordance with examples as disclosed herein. The encoding component 1525 is capable of, configured to, or operable to support a means for encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The CB part communication component 1530 is capable of, configured to, or operable to support a means for transmitting, based on the first decoding characteristics, the one or more first code block parts during corresponding first time-frequency resources of the set of multiple time-frequency resources. In some examples, the CB part communication component 1530 is capable of, configured to, or operable to support a means for transmitting, based on the second decoding characteristics, the one or more second code block parts associated with corresponding second time-frequency resources of the set of multiple time-frequency resources.

In some examples, the transmission of the one or more second code block parts is based on a scheme for cancellation of the decoded one or more first code block parts or decoded second code block parts from one or more respective signals associated with the one or more second code block parts.

In some examples, the first decoding characteristics include a first modulation and coding parameter that is lower than a second modulation and coding parameter of the second decoding characteristics, and where the first modulation and coding parameter and the second modulation and coding parameter include respective modulation and coding scheme values, respective modulation orders, respective coding rates, or any combination thereof.

In some examples, a value of the first modulation and coding parameter includes a fixed difference with respect to a value of the second and coding modulation parameter.

In some examples, the control signaling component 1565 is capable of, configured to, or operable to support a means for transmitting control signaling including an indication of a value of the first modulation and coding parameter.

In some examples, the first decoding characteristics include a first transmission power that is higher than a second transmission power of the second decoding characteristics.

In some examples, the first decoding characteristics include first channel conditions that are different than second channel conditions of the second decoding characteristics.

In some examples, the resource component 1555 is capable of, configured to, or operable to support a means for transmitting a message indicating a subset of the set of multiple time-frequency resources in which the one or more first code block parts are located.

In some examples, the one or more first code block parts are associated with a first channel estimation quality that is greater than a second channel estimation quality with which the one or more second code block parts are associated.

In some examples, the CB part communication component 1530 is capable of, configured to, or operable to support a means for transmitting the one or more first code block parts in a symbol of the set of multiple time-frequency resources that is adjacent to a symbol in which a reference signal is transmitted.

In some examples, the CB part communication component 1530 is capable of, configured to, or operable to support a means for transmitting, in first time-frequency resources of the plurality of time-frequency resources and based on a frequency-based comb structure including one or more first resource elements and one or more second resource elements, at least a portion of the one or more first code block parts and a reference signal, where the reference signal occupies the one or more first resource elements of the frequency-based comb structure and the at least a portion of the one or more first code block parts occupies the one or more second resource elements of the frequency-based comb structure.

In some examples, a first quantity of modulation symbols included in each of the one or more first code block parts is a same quantity as a second quantity of modulation symbols included in each of the one or more second code block parts.

In some examples, to support transmitting the set of multiple code block parts, the modulation and coding component 1550 is capable of, configured to, or operable to support a means for transmitting the set of multiple code block parts in a set of multiple symbols, where the one or more first code block parts are transmitted in a first-in-time symbol of the set of multiple symbols, no later than a reference symbol of the set of multiple symbols, no later than a first-in-time reference signal symbol of the set of multiple symbols, or no later than a last-in-time symbol of the set of multiple symbols.

In some examples, the reference symbol is an Nth-in-time symbol of the set of multiple symbols, and where N is a fixed value, N is based on a length of a transmission associated with the set of multiple code block parts, N is indicated via control signaling, or any combination thereof.

In some examples, at least a portion of the one or more first code block parts are associated with highest frequency resources of the set of multiple time-frequency resources, lowest frequency resources of the set of multiple time-frequency resources, or both.

In some examples, respective portions of the set of multiple code block parts associated with respective spatial layers of the set of multiple spatial layers are successively offset in the different time-frequency resources of the set of multiple time-frequency resources.

In some examples, the set of multiple spatial layers includes a first group of spatial layers and a second group of spatial layers. In some examples, one or more first portions of the set of multiple code block parts associated with the first group of spatial layers are offset in the different time-frequency resources of the set of multiple time-frequency resources with respect to one or more second portions of the set of multiple code block parts associated with the second group of spatial layers.

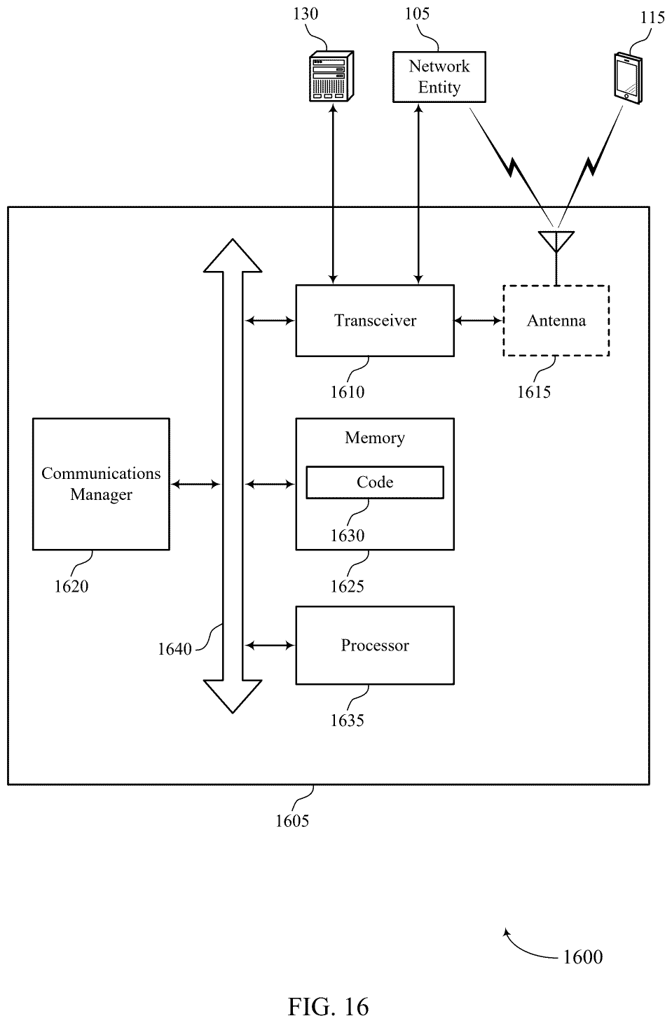

FIG. 16 shows a diagram of a system 1600 including a device 1605 that supports SC-MIMO transmissions with tail biting in accordance with one or more examples as disclosed herein. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting SC-MIMO transmissions with tail biting). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

Additionally, or alternatively, the communications manager 1620 may support wireless communications in accordance with examples as disclosed herein. For example, the communications manager 1620 is capable of, configured to, or operable to support a means for encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The communications manager 1620 is capable of, configured to, or operable to support a means for transmitting, based on the first decoding characteristics, the one or more first code block parts during corresponding first time-frequency resources of the set of multiple time-frequency resources. The communications manager 1620 is capable of, configured to, or operable to support a means for transmitting, based on the second decoding characteristics, the one or more second code block parts associated with corresponding second time-frequency resources of the set of multiple time-frequency resources.

By including or configuring the communications manager 1620 in accordance with examples as described herein, the device 1605 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of SC-MIMO transmissions with tail biting as described herein, or the at least one processor 1635 and the at least one memory 1625 may be otherwise configured to, individually or collectively, perform or support such operations.

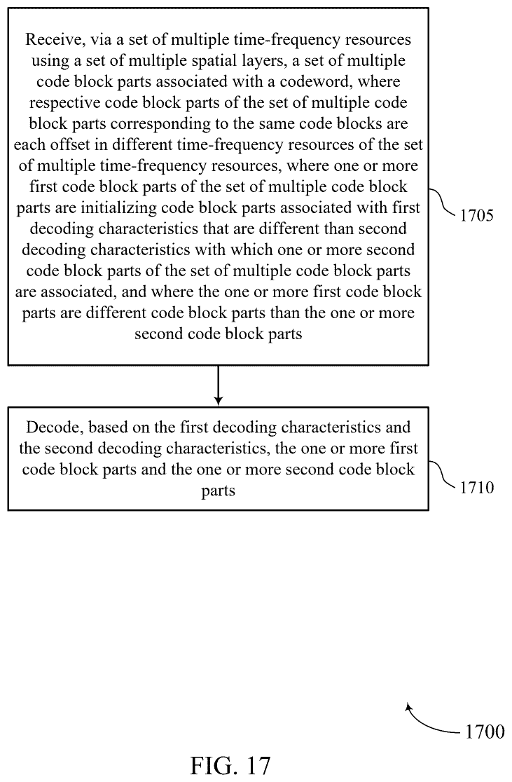

FIG. 17 shows a flowchart illustrating a method 1700 that supports SC-MIMO transmissions with tail biting in accordance with one or more examples as disclosed herein. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, via a set of multiple time-frequency resources using a set of multiple spatial layers, a set of multiple code block parts associated with a codeword, where respective code block parts of the set of multiple code block parts corresponding to the same code blocks are each offset in different time-frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The operations of 1705 may be performed in accordance with examples as disclosed herein. In some examples, aspects of the operations of 1705 may be performed by a CB part communication component 1125 as described with reference to FIG. 11.

At 1710, the method may include decoding, based on the first decoding characteristics and the second decoding characteristics, the one or more first code block parts and the one or more second code block parts. The operations of 1710 may be performed in accordance with examples as disclosed herein. In some examples, aspects of the operations of 1710 may be performed by a decoding component 1130 as described with reference to FIG. 11.

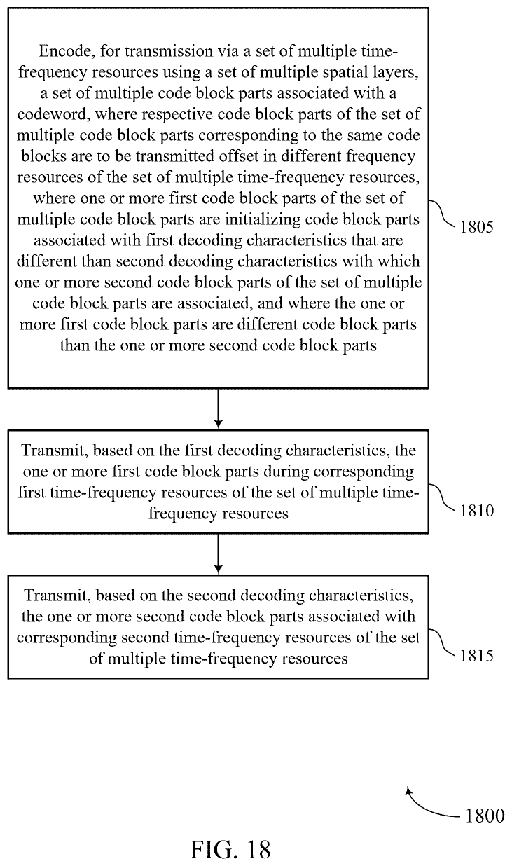

FIG. 18 shows a flowchart illustrating a method 1800 that supports SC-MIMO transmissions with tail biting in accordance with one or more examples as disclosed herein. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include encoding, for transmission via a set of multiple time-frequency resources using a set of multiple spatial layers, a set of multiple code block parts associated with a codeword, where respective code block parts of the set of multiple code block parts corresponding to the same code blocks are to be transmitted offset in different frequency resources of the set of multiple time-frequency resources, where one or more first code block parts of the set of multiple code block parts are initializing code block parts associated with first decoding characteristics that are different than second decoding characteristics with which one or more second code block parts of the set of multiple code block parts are associated, and where the one or more first code block parts are different code block parts than the one or more second code block parts. The operations of 1805 may be performed in accordance with examples as disclosed herein. In some examples, aspects of the operations of 1805 may be performed by an encoding component 1525 as described with reference to FIG. 15.

At 1810, the method may include transmitting, based on the first decoding characteristics, the one or more first code block parts during corresponding first time-frequency resources of the set of multiple time-frequency resources. The operations of 1810 may be performed in accordance with examples as disclosed herein. In some examples, aspects of the operations of 1810 may be performed by a CB part communication component 1530 as described with reference to FIG. 15.

At 1815, the method may include transmitting, based on the second decoding characteristics, the one or more second code block parts associated with corresponding second time-frequency resources of the set of multiple time-frequency resources. The operations of 1815 may be performed in accordance with examples as disclosed herein. In some examples, aspects of the operations of 1815 may be performed by a CB part communication component 1530 as described with reference to FIG. 15.

The following provides an overview of aspects of the present disclosure:
Aspect 1: A method for wireless communications at a UE, comprising: receiving, via a plurality of time-frequency resources using a plurality of spatial layers, a plurality of code block parts associated with a codeword, wherein respective code block parts of the plurality of code block parts corresponding to the same code blocks are each offset in different time-frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts; and decoding, based at least in part on the first decoding characteristics and the second decoding characteristics, the one or more first code block parts and the one or more second code block parts.
Aspect 2: The method of aspect 1, wherein decoding the one or more first code block parts and the one or more second code block parts comprises: decoding, successively and based at least in part on the second decoding characteristics, the one or more second code block parts associated with corresponding second time-frequency resources of the plurality of time-frequency resources based at least in part on cancellation of the decoded one or more first code block parts or decoded second code block parts from one or more respective signals associated with the one or more second code block parts and received during corresponding second time-frequency resources of the plurality of time-frequency resources.
Aspect 3: The method of aspect 2, wherein decoding, successively, the one or more second code block parts comprises: decoding respective first groups of second code block parts based at least in part on cancellation of respective second groups of second code block parts.
Aspect 4: The method of any of aspects 1 through 3, wherein the first decoding characteristics comprise a first modulation and coding parameter that is lower than a second modulation and coding parameter of the second decoding characteristics, and wherein the first modulation and coding parameter and the second modulation and coding parameter comprise respective modulation and coding scheme values, respective modulation orders, respective coding rates, or any combination thereof.
Aspect 5: The method of aspect 4, wherein a value of the first modulation and coding parameter comprises a fixed difference with respect to a value of the second modulation and coding parameter.
Aspect 6: The method of aspect 4, further comprising: receiving control signaling comprising an indication of a value of the first modulation and coding parameter.
Aspect 7: The method of any of aspects 1 through 6, wherein the first decoding characteristics comprise a first transmission power that is higher than a second transmission power of the second decoding characteristics.
Aspect 8: The method of any of aspects 1 through 6, wherein the first decoding characteristics comprise first channel conditions that are different than second channel conditions of the second decoding characteristics.
Aspect 9: The method of aspect 8, further comprising: receiving a message indicating a subset of the plurality of time-frequency resources in which the one or more first code block parts are located.
Aspect 10: The method of any of aspects 8 through 9, further comprising: determining the first decoding characteristics and the second decoding characteristics based at least in part on measuring the first channel conditions, the second channel conditions, or both; and determining the one or more first code block parts based at least in part on the determination of the first decoding characteristics and the second decoding characteristics.
Aspect 11: The method of any of aspects 1 through 10, wherein the one or more first code block parts are associated with a first channel estimation quality that is greater than a second channel estimation quality with which the one or more second code block parts are associated.
Aspect 12: The method of aspect 11, further comprising: receiving the one or more first code block parts in a symbol of the plurality of time-frequency resources that is adjacent to a symbol in which a reference signal is received.
Aspect 13: The method of aspect 11, further comprising: receiving, in the first time-frequency resources and based at least in part on a frequency-based comb structure comprising one or more first resource elements and one or more second resource elements, at least a portion of the one or more first code block parts and a reference signal, wherein the reference signal occupies the one or more first resource elements of the frequency-based comb structure and the at least a portion of the one or more first code block parts occupies the one or more second resource elements of the frequency-based comb structure.
Aspect 14: The method of any of aspects 1 through 13, wherein a first quantity of modulation symbols included in each of the one or more first code block parts is a same quantity as a second quantity of modulation symbols included in each of the one or more second code block parts
Aspect 15: The method of any of aspects 1 through 14, wherein receiving the plurality of code block parts comprises: receiving the plurality of code block parts in a plurality of symbols, wherein the one or more first code block parts are received in a first-in-time symbol of the plurality of symbols, no later than a reference symbol of the plurality of symbols, no later than a first-in-time reference signal symbol of the plurality of symbols, or no later than a last-in-time symbol of the plurality of symbols.
Aspect 16: The method of aspect 15, wherein the reference symbol is an N th-in-time symbol of the plurality of symbols, and wherein N is a fixed value, N is based at least in part on a length of a transmission associated with the plurality of code block parts, or N is indicated via control signaling, or any combination thereof.
Aspect 17: The method of any of aspects 1 through 16, wherein at least a portion of the one or more first code block parts are associated with highest frequency resources of the plurality of time-frequency resources, lowest frequency resources of the plurality of time-frequency resources, or both.
Aspect 18: The method of any of aspects 1 through 17, wherein respective portions of the plurality of code block parts associated with respective spatial layers of the plurality of spatial layers are successively offset in the different time-frequency resources of the plurality of time-frequency resources.
Aspect 19: The method of any of aspects 1 through 18, wherein the plurality of spatial layers comprises a first group of spatial layers and a second group of spatial layers; and one or more first portions of the plurality of code block parts associated with the first group of spatial layers are offset in the different time-frequency resources of the plurality of time-frequency resources with respect to one or more second portions of the plurality of code block parts associated with the second group of spatial layers.
Aspect 20: A method for wireless communications at a network entity, comprising: encoding, for transmission via a plurality of time-frequency resources using a plurality of spatial layers, a plurality of code block parts associated with a codeword, wherein respective code block parts of the plurality of code block parts corresponding to the same code blocks are to be transmitted offset in different frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts; transmitting, based at least in part on the first decoding characteristics, the one or more first code block parts during corresponding first time-frequency resources of the plurality of time-frequency resources; and transmitting, based at least in part on the second decoding characteristics, the one or more second code block parts associated with corresponding second time-frequency resources of the plurality of time-frequency resources.
Aspect 21: The method of aspect 20, wherein the transmission of the one or more second code block parts is based at least in part on a scheme for cancellation of the decoded one or more first code block parts or decoded second code block parts from one or more respective signals associated with the one or more second code block parts.
Aspect 22: The method of any of aspects 20 through 21, wherein the first decoding characteristics comprise a first modulation and coding parameter that is lower than a second modulation and coding parameter of the second decoding characteristics, and wherein the first modulation and coding parameter and the second modulation and coding parameter comprise respective modulation and coding scheme values, respective modulation orders, respective coding rates, or any combination thereof.
Aspect 23: The method of aspect 22, wherein a value of the first modulation and coding parameter comprises a fixed difference with respect to a value of the second and coding modulation parameter.
Aspect 24: The method of any of aspects 22 through 23, further comprising: transmitting control signaling comprising an indication of a value of the first modulation and coding parameter.
Aspect 25: The method of any of aspects 20 through 24, wherein the first decoding characteristics comprise a first transmission power that is higher than a second transmission power of the second decoding characteristics.
Aspect 26: The method of any of aspects 20 through 24, wherein the first decoding characteristics comprise first channel conditions that are different than second channel conditions of the second decoding characteristics.
Aspect 27: The method of aspect 26, further comprising: transmitting a message indicating a subset of the plurality of time-frequency resources in which the one or more first code block parts are located.
Aspect 28: The method of any of aspects 20 through 27, wherein the one or more first code block parts are associated with a first channel estimation quality that is greater than a second channel estimation quality with which the one or more second code block parts are associated.
Aspect 29: The method of aspect 28, further comprising: transmitting the one or more first code block parts in a symbol of the plurality of time-frequency resources that is adjacent to a symbol in which a reference signal is transmitted.
Aspect 30: The method of any of aspects 28 through 29, further comprising: transmitting, in the first time-frequency resources and based at least in part on a frequency-based comb structure comprising one or more first resource elements and one or more second resource elements, at least a portion of the one or more first code block parts and a reference signal, wherein the reference signal occupies the one or more first resource elements of the frequency-based comb structure and the at least a portion of the one or more first code block parts occupies the one or more second resource elements of the frequency-based comb structure.
Aspect 31: The method of any of aspects 20 through 30, wherein a first quantity of modulation symbols included in each of the one or more first code block parts is a same quantity as a second quantity of modulation symbols included in each of the one or more second code block parts.
Aspect 32: The method of any of aspects 20 through 31, wherein transmitting the plurality of code block parts comprises: transmitting the plurality of code block parts in a plurality of symbols, wherein the one or more first code block parts are transmitted in a first-in-time symbol of the plurality of symbols, no later than a reference symbol of the plurality of symbols, no later than a first-in-time reference signal symbol of the plurality of symbols, or no later than a last-in-time symbol of the plurality of symbols.
Aspect 33: The method of aspect 32, wherein the reference symbol is an Nth-in-time symbol of the plurality of symbols, and wherein N is a fixed value, N is based at least in part on a length of a transmission associated with the plurality of code block parts, N is indicated via control signaling, or any combination thereof.
Aspect 34: The method of any of aspects 20 through 33, wherein at least a portion of the one or more first code block parts are associated with highest frequency resources of the plurality of time-frequency resources, lowest frequency resources of the plurality of time-frequency resources, or both.
Aspect 35: The method of any of aspects 20 through 34, wherein respective portions of the plurality of code block parts associated with respective spatial layers of the plurality of spatial layers are successively offset in the different time-frequency resources of the plurality of time-frequency resources.
Aspect 36: The method of any of aspects 20 through 35, wherein the plurality of spatial layers comprises a first group of spatial layers and a second group of spatial layers; and one or more first portions of the plurality of code block parts associated with the first group of spatial layers are offset in the different time-frequency resources of the plurality of time-frequency resources with respect to one or more second portions of the plurality of code block parts associated with the second group of spatial layers.
Aspect 37: A UE for wireless communications, comprising one or more memories storing processor-executable code, and one or more processors coupled with the one or more memories and individually or collectively operable to execute the code to cause the UE to perform a method of any of aspects 1 through 19.
Aspect 38: A UE for wireless communications, comprising at least one means for performing a method of any of aspects 1 through 19.
Aspect 39: A non-transitory computer-readable medium storing code for wireless communications, the code comprising instructions executable by one or more processors to perform a method of any of aspects 1 through 19.
Aspect 40: A network entity for wireless communications, comprising one or more memories storing processor-executable code, and one or more processors coupled with the one or more memories and individually or collectively operable to execute the code to cause the network entity to perform a method of any of aspects 20 through 36.
Aspect 41: A network entity for wireless communications, comprising at least one means for performing a method of any of aspects 20 through 36.
Aspect 42: A non-transitory computer-readable medium storing code for wireless communications, the code comprising instructions executable by one or more processors to perform a method of any of aspects 20 through 36.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a plurality of time-frequency resources using a plurality of spatial layers, a plurality of code block parts associated with a codeword, wherein respective code block parts of the plurality of code block parts corresponding to the same code blocks are each offset in different time-frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts; and
decode, based at least in part on the first decoding characteristics and the second decoding characteristics, the one or more first code block parts and the one or more second code block parts.

2. The UE of claim 1, wherein, to decode the one or more first code block parts and the one or more second code block parts, the one or more processors are individually or collectively operable to execute the code to cause the UE to:
decode, successively and based at least in part on the second decoding characteristics, the one or more second code block parts associated with corresponding second time-frequency resources of the plurality of time-frequency resources based at least in part on cancellation of the decoded one or more first code block parts or decoded second code block parts from one or more respective signals associated with the one or more second code block parts and received during corresponding second time-frequency resources of the plurality of time-frequency resources.

3. The UE of claim 2, wherein, to decode, successively, the one or more second code block parts, the one or more processors are individually or collectively operable to execute the code to cause the UE to:
decode respective first groups of second code block parts based at least in part on cancellation of respective second groups of second code block parts.

4. The UE of claim 1, wherein the first decoding characteristics comprise a first modulation and coding parameter that is lower than a second modulation and coding parameter of the second decoding characteristics, and wherein the first modulation and coding parameter and the second modulation and coding parameter comprise respective modulation and coding scheme values, respective modulation orders, respective coding rates, or any combination thereof.

5. The UE of claim 4, wherein a value of the first modulation and coding parameter comprises a fixed difference with respect to a value of the second modulation and coding parameter.

6. The UE of claim 4, wherein the one or more processors are individually or collectively further operable to execute the code to cause the UE to:
receive control signaling comprising an indication of a value of the first modulation and coding parameter.

7. The UE of claim 1, wherein the first decoding characteristics comprise a first transmission power that is higher than a second transmission power of the second decoding characteristics.

8. The UE of claim 1, wherein the first decoding characteristics comprise first channel conditions that are different than second channel conditions of the second decoding characteristics.

9. The UE of claim 8, wherein the one or more processors are individually or collectively further operable to execute the code to cause the UE to:
receive a message indicating a subset of the plurality of time-frequency resources in which the one or more first code block parts are located.

10. The UE of claim 8, wherein the one or more processors are individually or collectively further operable to execute the code to cause the UE to:
determine the first decoding characteristics and the second decoding characteristics based at least in part on measuring the first channel conditions, the second channel conditions, or both; and
determine the one or more first code block parts based at least in part on the determination of the first decoding characteristics and the second decoding characteristics.

11. The UE of claim 1, wherein the one or more first code block parts are associated with a first channel estimation quality that is greater than a second channel estimation quality with which the one or more second code block parts are associated.

12. The UE of claim 11, wherein the one or more processors are individually or collectively further operable to execute the code to cause the UE to:
receive the one or more first code block parts in a symbol of the plurality of time-frequency resources that is adjacent to a symbol in which a reference signal is received.

13. The UE of claim 11, wherein the one or more processors are individually or collectively further operable to execute the code to cause the UE to:
receive, in first time-frequency resources of the plurality of time-frequency resources and based at least in part on a frequency-based comb structure comprising one or more first resource elements and one or more second resource elements, at least a portion of the one or more first code block parts and a reference signal, wherein the reference signal occupies the one or more first resource elements of the frequency-based comb structure and the at least a portion of the one or more first code block parts occupies the one or more second resource elements of the frequency-based comb structure.

14. The UE of claim 1, wherein a first quantity of modulation symbols included in each of the one or more first code block parts is a same quantity as a second quantity of modulation symbols included in each of the one or more second code block parts.

15. The UE of claim 1, wherein, to receive the plurality of code block parts, the one or more processors are individually or collectively operable to execute the code to cause the UE to:
receive the plurality of code block parts in a plurality of symbols, wherein the one or more first code block parts are received in a first-in-time symbol of the plurality of symbols, no later than a reference symbol of the plurality of symbols, no later than a first-in-time reference signal symbol of the plurality of symbols, or no later than a last-in-time symbol of the plurality of symbols.

16. The UE of claim 15, wherein the reference symbol is an Nth-in-time symbol of the plurality of symbols, and wherein N is a fixed value, N is based at least in part on a length of a transmission associated with the plurality of code block parts, or N is indicated via control signaling, or any combination thereof.

17. The UE of claim 1, wherein at least a portion of the one or more first code block parts are associated with highest frequency resources of the plurality of time-frequency resources, lowest frequency resources of the plurality of time-frequency resources, or both.

18. The UE of claim 1, wherein respective portions of the plurality of code block parts associated with respective spatial layers of the plurality of spatial layers are successively offset in the different time-frequency resources of the plurality of time-frequency resources.

19. The UE of claim 1, wherein:
the plurality of spatial layers comprises a first group of spatial layers and a second group of spatial layers; and
one or more first portions of the plurality of code block parts associated with the first group of spatial layers are offset in the different time-frequency resources of the plurality of time-frequency resources with respect to one or more second portions of the plurality of code block parts associated with the second group of spatial layers.

20. A network entity, comprising:
one or more memories storing processor-executable code; and
one or more processors coupled with the one or more memories and individually or collectively operable to execute the code to cause the network entity to:
encode, for transmission via a plurality of time-frequency resources using a plurality of spatial layers, a plurality of code block parts associated with a codeword, wherein respective code block parts of the plurality of code block parts corresponding to the same code blocks are to be transmitted offset in different frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts;
transmit, based at least in part on the first decoding characteristics, the one or more first code block parts during corresponding first time-frequency resources of the plurality of time-frequency resources; and
transmit, based at least in part on the second decoding characteristics, the one or more second code block parts associated with corresponding second time-frequency resources of the plurality of time-frequency resources.

21. The network entity of claim 20, wherein the transmission of the one or more second code block parts is based at least in part on a scheme for cancellation of the decoded one or more first code block parts or decoded second code block parts from one or more respective signals associated with the one or more second code block parts.

22. The network entity of claim 20, wherein the first decoding characteristics comprise a first modulation and coding parameter that is lower than a second modulation and coding parameter of the second decoding characteristics, and wherein the first modulation and coding parameter and the second modulation and coding parameter comprise respective modulation and coding scheme values, respective modulation orders, respective coding rates, or any combination thereof.

23. The network entity of claim 20, wherein the first decoding characteristics comprise a first transmission power that is higher than a second transmission power of the second decoding characteristics.

24. The network entity of claim 20, wherein the first decoding characteristics comprise first channel conditions that are different than second channel conditions of the second decoding characteristics.

25. The network entity of claim 20, wherein the one or more first code block parts are associated with a first channel estimation quality that is greater than a second channel estimation quality with which the one or more second code block parts are associated.

26. The network entity of claim 20, wherein a first quantity of modulation symbols included in each of the one or more first code block parts is a same quantity as a second quantity of modulation symbols included in each of the one or more second code block parts.

27. The network entity of claim 20, wherein, to transmit the plurality of code block parts, the one or more processors are individually or collectively operable to execute the code to cause the network entity to:
transmit the plurality of code block parts in a plurality of symbols, wherein the one or more first code block parts are transmitted in a first-in-time symbol of the plurality of symbols, no later than a reference symbol of the plurality of symbols, no later than a first-in-time reference signal symbol of the plurality of symbols, or no later than a last-in-time symbol of the plurality of symbols.

28. The network entity of claim 20, wherein at least a portion of the one or more first code block parts are associated with highest frequency resources of the plurality of time-frequency resources, lowest frequency resources of the plurality of time-frequency resources, or both.

29. A method for wireless communications at a user equipment (UE), comprising:
receiving, via a plurality of time-frequency resources using a plurality of spatial layers, a plurality of code block parts associated with a codeword, wherein respective code block parts of the plurality of code block parts corresponding to the same code blocks are each offset in different time-frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts; and
decoding, based at least in part on the first decoding characteristics and the second decoding characteristics, the one or more first code block parts and the one or more second code block parts.

30. A method for wireless communications at a network entity, comprising:
encoding, for transmission via a plurality of time-frequency resources using a plurality of spatial layers, a plurality of code block parts associated with a codeword, wherein respective code block parts of the plurality of code block parts corresponding to the same code blocks are to be transmitted offset in different frequency resources of the plurality of time-frequency resources, wherein one or more first code block parts of the plurality of code block parts are initializing code block parts associated with first decoding characteristics that are different than second decoding characteristics with which one or more second code block parts of the plurality of code block parts are associated, and wherein the one or more first code block parts are different code block parts than the one or more second code block parts;
transmitting, based at least in part on the first decoding characteristics, the one or more first code block parts during corresponding first time-frequency resources of the plurality of time-frequency resources; and
transmitting, based at least in part on the second decoding characteristics, the one or more second code block parts associated with corresponding second time-frequency resources of the plurality of time-frequency resources.
